(19) United States
(12) Patent Application Publication
(10) Pub. No.: US 2026/0036919 A1
(43) Pub. Date: Feb. 5, 2026

(54) TONER

(71) Applicant: CANON KABUSHIKI KAISHA, Tokyo (JP)

(72) Inventors: SHOHEI SHIBAHARA, Shizuoka (JP); YUU SASANO, Shizuoka (JP); TOHRU HIRAMATSU, Shizuoka (JP); HIROKI KAGAWA, Shizuoka (JP)

(21) Appl. No.: 19/277,617

(22) Filed: Jul. 23, 2025

(30) Foreign Application Priority Data
Jul. 30, 2024 (JP) 2024-123373
Jul. 1, 2025 (JP) 2025-111498

(51) Int. Cl. G03G 9/093

(52) U.S. Cl. CPC G03G 9/09364; G03G 9/09328

(57) ABSTRACT

A toner including: a toner particle; and an inorganic fine particle, wherein the inorganic fine particle contains a strontium titanate fine particle, a Si-containing protrusion portion is present at a surface of the strontium titanate fine particle, and the toner contains an amorphous polyester resin and an aluminum element at a surface of the toner particle.

### BACKGROUND

### Field of the Technology

The present disclosure relates to a toner that is used in an image forming method such as an electrophotographic method.

### Description of the Related Art

In recent years, for copiers or printers, increase in speed, service life extension, and environmental stability improvement have been underway, and for toners, stress resistance that enables toners to withstand friction in cartridges in long-term high-speed printing and stable image quality that is not affected by usage environments have been required.

In order to improve stress resistance, for example, Japanese Patent Application Laid-open No. 2000-147831 discloses means for incorporating an amorphous polyester resin into a toner particle. In addition, from the viewpoint of charging characteristics, Japanese Patent Application Laid-open No. 2008-107769 discloses means for crosslinking an amorphous polyester resin with an aluminum element.

### SUMMARY

However, even in the case of using such measures, there is still room for improvement in an environment where charging is difficult to stabilize, such as a low-temperature and low-humidity environment, in copiers or printers that are operated at high speeds over an extended service life. Even in the case of a toner having durability or chargeability improved by an amorphous polyester resin or an aluminum element, an inorganic fine particle at the surface of a toner particle is likely to migrate to a member in a developing unit from the toner particle in a high-speed machine.

This tendency becomes prominent particularly in a low-temperature and low-humidity environment. In the low-temperature and low-humidity environment, it is likely to be difficult to obtain a stable image density in combination with the fact that the toner is likely to be excessively charged. Specifically, in a case where a large number of images of the same pattern are printed in a low-temperature and low-humidity environment, the toner is likely to be unevenly charged in a printing portion and a non-printing portion on a developing sleeve. When different images are continuously printed with the toner unevenly charged, the history of a previous image may cause a difference in density of an image in printing, which is an adverse effect.

The present disclosure provides a toner that achieves a stable image density over a long period of time in a high-speed machine even in a low-temperature and low-humidity environment.

The present disclosure relates to a toner comprising: a toner particle; and an inorganic fine particle, wherein the inorganic fine particle contains a strontium titanate fine particle, a Si-containing protrusion portion is present at a surface of the strontium titanate fine particle, and the toner contains an amorphous polyester resin and an aluminum element at a surface of the toner particle.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are schematic views of a measuring instrument of a powder specific resistance value.

FIG. 2 is a schematic view of a measuring instrument of a frictional charge amount.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

The present inventors consider the reason for a toner according to the present disclosure being capable of achieving a stable image density over a long period of time in a high-speed machine even in a low-temperature and low-humidity environment as follows.

When an amorphous polyester resin is crosslinked with an aluminum element, the durability of a toner improves; however, in a low-temperature and low-humidity environment, there is a problem in that the toner is excessively charged and a difference in density of an image is caused. One factor of this problem is that in a low-temperature and low-humidity environment, an inorganic fine particle at the surface of a toner particle is likely to migrate and an inorganic fine particle that does not migrate but remains at the surface of the toner particle is likely to be unevenly charged.

As a means for eliminating the difference in density of an image, strontium titanate having low powder resistance may be used. However, a strontium titanate fine particle is a positive inorganic fine particle and is thus likely to be repulsed by a similarly positive aluminum element and to migrate to other members from the toner particle, which still leaves the difference in density unresolved.

As a result of intensive studies, the present inventors found that the use of a strontium titanate fine particle having a Si-containing protrusion portion at the surface in a toner particle containing an amorphous polyester resin and an aluminum element is effective for improvement in the migration of an inorganic fine particle or excessive charging described above.

Since the aluminum element is an atom that is likely to be positively polarized, there is a more prominently occurring problem in that the aluminum element is likely to cause electrostatic repulsion with respect to an inorganic fine particle that is, similarly, likely to be positively polarized and the inorganic fine particle is likely to migrate to other members in a developing unit. At the surface of a toner where some inorganic fine particles have migrated to other members, uneven charging is likely to occur.

On the other hand, since the protrusion portion of the strontium titanate fine particle having a Si-containing protrusion portion at the surface is likely to be negatively polarized, repulsion with the aluminum element is less likely to occur, and the strontium titanate fine particle is less likely to migrate from the surface of the toner even in a low-temperature and low-humidity environment. In addition, since the resistance value of a strontium titanate site is not too high, it is possible to rapidly transfer electrons to the aluminum element or the amorphous polyester resin, and excessive charging in a low-temperature and low-humidity environment is suppressed. The migration of the strontium titanate fine particle having a Si-containing protrusion portion at the surface can be evaluated by measuring the adhesion rate to be described below. The higher the value of the adhesion rate, the more difficult it is for the inorganic fine particle to migrate to other members from the toner particle.

Hereinafter, a preferable constitution of the toner will be described.

The abundance Sp (%) of the amorphous polyester resin at the surface of the toner particle by time-of-flight secondary ion mass spectrometry is preferably 50% or more. When Sp is 50% or more, the durability of the toner improves, and it becomes easy to transfer electrons to the inorganic fine particle. In addition, Sp is more preferably 60% or more and still more preferably 70% or more to enhance the above-described effect.

The abundance Sp is preferably 50% to 98%, more preferably 60% to 95%, and still more preferably 70% to 92%. Sp can be controlled by the amount of the amorphous polyester resin that is added as a resin of the shell.

At the surface of the toner particle, the content C_{Al} of the aluminum element that is obtained by energy dispersive X-ray analysis is, for example, 7.0×10⁻⁴ to 2.5 atomic % and preferably 1.0×10⁻³ to 2.0 atomic %. When the C_{Al} is 1.0×10⁻³ atomic % or more, the durability of the toner further improves, and furthermore, it is possible to make it easy to transfer electrons to the inorganic fine particle. In addition, when the C_{Al} is 2.0 atomic % or less, the transfer of electrons becomes more appropriate, and it becomes easier to keep the toner charged. When the toner can be kept charged, the amount of the toner applied on the developing sleeve increases, which makes it possible to increase the image density.

In order to further enhance the above-described effect, the C_{Al} is more preferably 3.0×10⁻³ to 1.0 atomic % and still more preferably 5.0×10⁻³ to 0.5 atomic %.

The C_{Al} can be controlled by, for example, the amount added or concentration of an aggregating agent containing aluminum.

The abundance S_{ST} (area %) of the strontium titanate fine particle having a Si-containing protrusion portion at the surface that is calculated from a SEM observation image of the surface of the toner is, for example, 2.5 to 55.0 area % and preferably 3.0 to 50.0 area %. When the S_{ST} is 3.0 area % or more, it becomes easy to transfer electrons to the toner particle, and it is possible to make it easier to suppress excessive charging. In addition, when the S_{ST} is 50.0 area % or less, the transfer of electrons becomes more appropriate, and it becomes easier to keep the toner charged.

In order to enhance the above-described effect, the S_{ST} is more preferably 5.0 to 45.0 area % and still more preferably 10.0 to 40.0 area %.

The value of the ratio (S_{ST}/C_{Al}) of the abundance S_{ST} of the strontium titanate fine particle having a Si-containing protrusion portion at the surface to the content CMI of the aluminum element is, for example, 13 to 4.0×10⁴ and preferably 20 to 2.5×10⁴. When the S_{ST}/C_{Al} is 20 or more, the amount of the strontium titanate fine particle having a Si-containing protrusion portion at the surface relative to the aluminum element at the surface of the toner particle becomes sufficient, and the transfer of electrons is more likely to occur. In addition, when the S_{ST}/C_{Al} is 2.5×10⁴ or less, the amount of the strontium titanate fine particle having a Si-containing protrusion portion at the surface relative to the aluminum element is appropriate, and it is possible to make it easier to keep the toner charged.

In order to further enhance the above-described effect, the S_{ST}/C_{Al} is more preferably 50 to 1.5×10⁴ and still more preferably 100 to 0.5×10⁴.

The powder specific resistance value of the strontium titanate fine particle having a Si-containing protrusion portion at the surface is, for example, 7.0×10⁸ to 1.4×10¹¹ Ω·cm and preferably 1.0×10⁹ to 1.0×10¹¹ Ω·cm. When the powder specific resistance value is 1.0×10⁹ Ω·cm or more, it is possible to make it easier to keep the toner charged. When the powder specific resistance value is 1.0×10¹¹ Ω·cm or less, it is easier to prevent the toner from being excessively charged.

In order to further enhance the above-described effect, the powder specific resistance value is more preferably 3.0×10⁹ to 0.8×10¹¹ Ω·cm and still more preferably 7.0×10⁹ to 0.5×10¹¹ Ω·cm.

The powder specific resistance value of the strontium titanate fine particle having a Si-containing protrusion portion at the surface can be controlled by the particle size of the strontium titanate fine particle, the amount of Si added during production, and the kind and content of a surface treatment agent.

The Bragg angle of the strontium titanate fine particle having a Si-containing protrusion portion at the surface is indicated by Θ. At this time, the strontium titanate fine particle preferably has peaks in ranges of 39.700°±0.150° and 46.200°±0.150°, respectively, in a CuKα X-ray diffraction spectrum that is obtained in a 2Θ range of 10° to 90°. In addition, when the area of the peak at 39.700°±0.150° is indicated by Sa, and the area of the peak at 46.200°±0.150° is indicated by Sb, the Sb/Sa is, for example, 1.70 to 2.40 and preferably 1.80 to 2.30.

Strontium titanate having peaks at these positions has a perovskite structure belonging to the cubic system, and peaks a and b in the ranges of 39.700°±0.150° and 46.200°±0.150° are diffraction peaks derived from lattice planes of Miller indices (111) and (200), respectively.

Generally, a particle belonging to the cubic system is likely to have a hexahedral shape as the appearance shape of the particle, and the strontium titanate fine particle also grows while having a (100) plane and a (200) plane that correspond to the plane directions of the hexahedral shape in a production process. In the case of using the strontium titanate fine particle having a (200) plane corresponding to the plane direction of the hexahedral shape and a (111) plane corresponding to the apical direction, it is possible to make it difficult for the strontium titanate fine particle to migrate from the toner particle.

In order to further enhance the above-described effect, the Sb/Sa is more preferably 1.85 to 2.25 and still more preferably 1.90 to 2.20.

The amorphous polyester resin is preferably a condensation polymer of an acid component and an alcohol component. The content percentage Uᵢₛₒ of a monomer unit derived from isophthalic acid based on all monomer units derived from the acid component in the amorphous polyester resin is, for example, 50 mol % or more and preferably 60 mol % or more. When the Uᵢₛₒ is 60 mol % or more, since it becomes easy for the amorphous polyester resin to interact with the aluminum element, durability is further improved, and it is possible to make it easier to transfer electrons. In order to further enhance the above-described effect, the Uᵢₛₒ is more preferably 80 mol % or more and still more preferably 90 mol % or more. The Uᵢₛₒ is, for example, 50 to 99 mol %, preferably 60 to 99 mol %, more preferably 80 to 98 mol %, and still more preferably 90 to 97 mol %.

In the present disclosure, “monomer unit” refers to a reacted form of a monomer substance in the polymer. For example, in the amorphous polyester resin, a monomer substance between ester bonds is defined as one unit. In addition, in mol % calculations, the one unit corresponds to one molecule.

The fact that a monomer unit is derived from a certain monomer substance can be confirmed from the fact that the structure of the monomer unit corresponds to the reacted structure of the certain monomer substance.

The content percentage of the monomer unit derived from isophthalic acid based on all of the monomer units derived from the acid component of the amorphous polyester resin is, for example, 50 to 99 mass %, preferably 60 to 99 mass %, more preferably 80 to 98 mass %, and still more preferably 90 to 97 mass %.

The toner particle preferably contains a crystalline polyester resin. The crystalline polyester resin is generally a material that easily transfers electrons compared with amorphous polyesters and thus makes it possible to facilitate suppression of excessive charging in a low-temperature and low-humidity environment.

A crystalline resin refers to a resin having a clear endothermic peak in differential scanning calorimetry (DSC).

In order to enhance the above-described effect, the content of the crystalline polyester resin is preferably 1 part by mass or more and preferably 20 parts by mass or less to make it easy to keep the toner charged based on 100 parts by mass of the toner. Furthermore, the content of the crystalline polyester resin is more preferably from 3 parts by mass to 15 parts by mass to enhance the above-described effect.

The toner particle preferably contains at least one selected from the group consisting of dodecylbenzenesulfonic acid and dodecylbenzene sulfonate. Since a sulfonic acid site of the dodecylbenzenesulfonic acid is likely to coordinate with the aluminum element, the transfer of electrons in the toner particle is more likely to occur. Examples of the salt include sodium salts and potassium salts, and sodium salts are preferable.

The content of the strontium titanate fine particle having a Si-containing protrusion portion at the surface is preferably 0.10 to 3.00 parts by mass, more preferably 0.10 to 1.20 parts by mass, and still more preferably 0.15 to 0.80 parts by mass, with respect to 100 parts by mass of the toner particle.

The adhesion rate of the strontium titanate fine particle having a Si-containing protrusion portion at the surface in the toner is preferably 80% to 99%, more preferably 85% to 99%, and still more preferably 87% to 97%. The higher the value of the adhesion rate, the more difficult it is for the strontium titanate fine particle to migrate to other members from the toner particle.

Each component constituting the toner and a method for producing the toner will be described in more detail.

Strontium Titanate Fine Particle Having Si-Containing Protrusion Portion at Surface

The strontium titanate fine particle having a Si-containing protrusion portion at the surface can be produced by, for example, a normal pressure heating reaction method. At this time, a mineral acid peptized product of a hydrolysate of a titanium compound can be used as a titanium oxide source, and a water-soluble acidic strontium source compound can be used as a strontium source.

The strontium titanate fine particle has a Si-containing protrusion portion at the surface. The protrusion portion is preferably formed of a silica fine particle. Examples of the protrusion portion include a protrusion portion formed by embedding a silica fine particle therein and a protrusion portion formed by making a silica fine particle adhere thereto. The same effect is exhibited in both the protrusion portion formed by embedding a silica fine particle therein and the protrusion portion formed by making a silica fine particle adhere thereto instead of embedding. The strontium titanate fine particle of the present disclosure is a fine particle including a Si-containing protrusion portion at the surface thereof.

The Si-containing protrusion portion can be formed by adding a silica-containing particle source at the time of producing the strontium titanate fine particle. The Si-containing protrusion portion will be specifically described below. The number average particle size of the particle in the protrusion portion is preferably less than 5 nm from the viewpoint of chargeability. The number average particle size of the particle in the protrusion portion is preferably at least 1 nm and less than 5 nm.

In a method for forming the Si-containing protrusion portion at the surface of the strontium titanate fine particle, a mineral acid peptized product of a hydrolysate of a titanium compound, a strontium source, and a silica-containing particle source are mixed together. In addition, the raw materials are reacted together while an alkaline aqueous solution is added to a mixed liquid of the raw materials at 60° C. to 100° C., and an acid treatment is then performed. The protrusion portion can be produced by such a method.

Hereinafter, the normal pressure heating reaction method will be described.

As the titanium oxide source, a mineral acid peptized product of a hydrolysate of a titanium compound is used. It is preferable to use a peptized product of metatitanic acid having a SO₃ content of 1.0 mass % or less, more preferably 0.5 mass % or less, obtained by a sulfuric acid method obtained by adjusting the pH with hydrochloric acid to 0.8 to 1.5.

Incidentally, as the strontium source, a nitrate, hydrochloride, or the like of strontium can be used.

As the nitrate, for example, strontium nitrate can be used. As the hydrochloride, for example, strontium chloride can be used. The strontium titanate fine particle obtained here has a perovskite crystal structure, and the environmental stability of charging thus further improves, which is preferable.

Subsequently, the shape control will be described. In order to obtain the above-described shape of the strontium titanate fine particle, a dry mechanical treatment may be performed as an example.

For example, a hybridizer (manufactured by Nara Machinery), NOBILTA (manufactured by Hosokawa Micron Corporation), MECHANO FUSION (manufactured by Hosokawa Micron Corporation), HIGH FLEX GRAL (manufactured by EARTHTECHNICA Co., Ltd.), and the like can be used. When the strontium titanate fine particle is treated with these devices and the treatment time is adjusted, it is easy to control the Sb/Sa to be from 1.80 to 2.30. The longer the treatment time, the smaller the Sb/Sa is, and the shorter the treatment time, the larger the Sb/Sa is.

In the case of controlling the shape of the strontium titanate fine particle by the mechanical treatment, a fine powder of the strontium titanate fine particle may be generated. In order to remove the fine powder, an acid treatment is preferably performed after the mechanical treatment. In the acid treatment, the pH is preferably adjusted to 0.1 to 5.0 using hydrochloric acid. As the acid, aside from hydrochloric acid, nitric acid, acetic acid and the like can be used in the acid treatment. The mechanical treatment for controlling the shape of the strontium titanate fine particle is preferably performed before the surface treatment of the strontium titanate fine particle is performed.

Examples of the silica-containing particle source include sodium silicate, silica, and the like. The addition of the silica-containing particle source makes it possible to form the Si-containing protrusion portion. In addition, from the viewpoint of easily canceling the positivity of the strontium titanate site, at the surface of the Si-containing protrusion portion, an Si element is preferably exposed at the surface.

The amount of the silica-containing particle source added is a factor that affects the Si-containing protrusion portion present at the surface of the strontium titanate fine particle and can be appropriately adjusted to obtain a target particle size and a target particle shape. In order not to inhibit the leakage of the charging of the strontium titanate site, the particle size of the silica-containing particle is preferably less than 5 nm.

As the alkaline aqueous solution, a caustic alkali can be used, and a sodium hydroxide aqueous solution is particularly preferable.

Examples of the factors that affect the particle size of the strontium titanate fine particle to be obtained and the Si-containing protrusion portion present at the surface of the strontium titanate fine particle in the production method include the following.

The pH at the time of the peptization of the metatitanic acid with hydrochloric acid, the mixing percentages of the titanium oxide source, the strontium source, and the silica-containing particle source, the concentration of the titanium oxide source and the concentration of the silica-containing particle source in the initial stage of the reaction, the temperature and addition rate at the time of adding the alkaline aqueous solution, the reaction time, the stirring conditions, and the like.

In addition, in a step of adding the alkaline aqueous solution, the half-value width of the strontium titanate fine particle can be controlled by adding the alkaline aqueous solution while ultrasonic vibration is applied thereto. The application of the ultrasonic vibration in a reaction step makes the precipitation rate of crystals fast and makes it possible to obtain a particle having a small crystallite diameter. It is preferable to rapidly cool an aqueous solution for which the reaction has been ended by the addition of the alkaline aqueous solution in terms of controlling the half-value width.

Examples of a method for the rapid cooling include a method in which pure water cooled to 10° C. or lower is added until the aqueous solution reaches a desired temperature. The rapid cooling makes it possible to suppress an increase in the crystallite diameter in the cooling step.

In addition, when the reaction is stopped by injecting a system into ice water or the like to rapidly decrease the temperature of the system after the addition of the alkaline aqueous solution, it is possible to forcibly stop the reaction in the middle of saturation of the crystal growth and to control the particle size distribution.

Furthermore, the particle size distribution can be controlled by putting the reaction system into an uneven state by reducing the stirring rate, changing the stirring method, or the like. These factors can be adjusted as appropriate to obtain the strontium titanate fine particle having desired particle size and particle size distribution and the Si-containing protrusion portion.

It is preferable to prevent the incorporation of carbon dioxide by causing the reaction in a nitrogen gas atmosphere to prevent the generation of carbonate in a reaction process.

The mixing percentages of the titanium oxide source and the strontium source at the time of the reaction is preferably from 0.90 to 1.40 and more preferably from 1.05 to 1.20 in terms of the molar ratio of SrO/TiO₂ when strontium is indicated by Sr and an oxide thereof is indicated by SrO.

In a case where the SrO/TiO₂ (molar ratio) is 1.00 or less, not only metal titanate but also unreacted titanium oxide are likely to remain in a reaction product. Since the titanium oxide source has relatively low solubility in water compared with strontium having high solubility in water, in a case where the SrO/TiO₂ (molar ratio) is 1.00 or less, there is a tendency that not only metal titanate but also unreacted titanium oxide are likely to remain in the reaction product.

The concentration of the titanium oxide source at the initial stage of the reaction is preferably from 0.050 mol/L to 1.300 mol/L and more preferably from 0.080 mol/L to 1.200 mol/L in terms of TiO₂. When the concentration of the titanium oxide source in the initial stage of the reaction is increased, it is possible to decrease the number average particle size of the primary particle of the strontium titanate fine particle.

Practically, the temperature at the time of adding the alkaline aqueous solution is preferably in a range of 60° C. to 100° C. since a pressure vessel such as an autoclave is required when the temperature is 100° C. or higher.

In addition, regarding the addition rate of the alkaline aqueous solution, as the addition rate becomes slower, the strontium titanate fine particle having a larger particle size and the larger protrusion portion formed of silica can be obtained. On the other hand, as the addition rate becomes faster, the strontium titanate fine particle having a smaller particle size and the smaller protrusion portion formed of silica can be obtained.

The addition rate of the alkaline aqueous solution is preferably from 0.001 equivalent/h to 1.2 equivalents/h and more preferably from 0.002 equivalents/h to 1.1 equivalents/h relative to the charged raw materials. These can be adjusted as appropriate depending on a particle size desired to be obtained.

In the production method, it is preferable to further perform an acid treatment on the strontium titanate fine particle obtained by the normal pressure heating reaction. At the time of producing the strontium titanate fine particle by performing a normal pressure heating reaction, in a case where the mixing percentages of the titanium oxide source and the strontium source is greater than 1.00 in terms of the SrO/TiO₂ (molar ratio), the unreacted strontium remaining after the end of the reaction may react with carbon dioxide in the air to generate an impurity such as carbonate. In order to make it easy to uniformly apply a surface treatment agent, it is preferable to perform the acid treatment to remove an unreacted metal source after the addition of the aqueous alkali solution.

In the acid treatment, the pH is preferably adjusted to 2.5 to 7.0 and more preferably adjusted to 4.5 to 6.0 using hydrochloric acid.

As the acid, aside from hydrochloric acid, nitric acid, acetic acid and the like can be used in the acid treatment. When sulfuric acid is used, a metal sulfate having a low solubility in water is likely to be generated.

The shape of the strontium titanate fine particle may be controlled. The strontium titanate fine particle preferably has a cubic shape or a rectangular shape. In addition, as a method for controlling the shape of the strontium titanate fine particle, a method of performing a dry mechanical treatment may be used.

The strontium titanate fine particle may be surface-treated. A surface treatment agent is not particularly limited, and examples thereof include disilylamine compounds, halogenated silane compounds, silicone compounds, or silane coupling agents.

The disilylamine compound is a compound having a disilylamine (Si—N—Si) site. Examples of the disilylamine compounds include hexamethyldisilazanes (HMIDS), N-methyl-hexamethyldisilazanes, or hexamethyl-N-propyldisilazanes. Examples of the halogenated silane compounds include dimethyldichlorosilane.

Examples of the silicone compounds include silicone oils or silicone resins (varnishes). Examples of the silicone oils include dimethyl silicone oils, methyl phenyl silicone oils, α-methyl styrene-modified silicone oils, chlorophenyl silicone oils, or fluorine-modified silicone oils. Examples of the silicone resins (varnishes) include methyl silicone varnishes and phenylmethyl silicone varnishes.

Examples of silane coupling agents include silane coupling agents having an alkyl group and an alkoxy group, silane coupling agents having an amino group and an alkoxy group, or fluorine-containing silane coupling agents.

More specific examples of the silane coupling agents include dimethyldimethoxysilane, dimethyldiethoxysilane, diethyldimethoxysilane, diethyldiethoxysilane, trimethylmethoxysilane, trimethyldiethoxysilane, triethylmethoxysilane, triethyldiethoxysilane, propyltrimethoxysilane, propyltriethoxysilane, isobutyltrimethoxysilane, octyltrimethoxysilane, octyltriethoxysilane, γ-glycidoxypropyltrimethoxysilane, 7-chloropropyltrimethoxysilane, γ-aminopropyltriethoxysilane, 7-aminopropyltrimethoxysilane, γ-aminopropyldimethoxylmethylsilane, or γ-aminopropyldiethoxymethylsilane, 3,3,3-trifluoropropyldimethoxysilane, 3,3,3-trifluoropropyldiethoxysilane, perfluorooctylethyltriethoxysilane, 1,1,1-trifluorohexyldiethoxysilane, and the like.

The silane coupling agent is preferably a silane coupling agent having an alkyl group and an alkoxy group such as dimethyldimethoxysilane, dimethyldiethoxysilane, diethyldimethoxysilane, diethyldiethoxysilane, trimethylmethoxysilane, trimethyldiethoxysilane, triethylmethoxysilane, triethyldiethoxysilane, propyltrimethoxysilane, propyltriethoxysilane, isobutyltrimethoxysilane, octyltrimethoxysilane, or octyltriethoxysilane.

The strontium titanate fine particle is preferably treated with, among the above-listed silane coupling agents, propyltrimethoxysilane or isobutyltrimethoxysilane, and propyltrimethoxysilane is more preferable.

In addition, a preferable amount of the treatment agent used to treat the strontium titanate fine particle is an amount of 0.5 to 25.0 parts by mass relative to 100 parts by mass of the strontium titanate fine particle. The surface treatment agents may be used singly or two or more thereof may be used in combination.

### Other Inorganic Fine Particle

The toner may contain other inorganic fine particle in addition to the strontium titanate fine particle having a Si-containing protrusion portion at the surface. Specific examples of the other inorganic fine particle include a silica fine particle, a hydrotalcite particle, an inorganic fine particle of titanium oxide or the like, and a resin fine particle of a vinyl-based resin, a polyester resin, a silicone resin, or the like. These inorganic fine particles are preferably added by, for example, applying a shear force thereto in a dry state.

### Amorphous Polyester Resin

The toner needs to contain an amorphous polyester resin at the surface of the toner particle. As the amorphous polyester resin, a resin obtained by condensation polymerization of a carboxylic acid component and an alcohol component, which will be described below, can be used.

Examples of the carboxylic acid component include terephthalic acid, isophthalic acid, phthalic acid, fumaric acid, maleic acid, cyclohexanedicarboxylic acid, trimellitic acid, and the like.

Examples of the alcohol component include aliphatic diols such as ethylene glycol, 1,2-propylene glycol, 1,4-butanediol, 1,5-pentanediol, 1,6-hexanediol, diethylene glycol, dipropylene glycol, triethylene glycol, and neopentyl glycol; bisphenols such as bisphenol A and hydrogenated bisphenols; bisphenol A alkylene oxide adducts such as ethylene oxide adducts of bisphenol A and propylene oxide adducts of bisphenol A; glycerin, trimethylol propane, pentaerythritol, and the like.

Among these, isophthalic acid is preferably used as described above. The carboxylic acid component preferably contains terephthalic acid or isophthalic acid.

In addition, alcohol components that are preferably used among these are ethylene oxide adducts of bisphenol A, propylene oxide adducts of bisphenol A, ethylene glycol, glycerin, and the like. The alcohol component preferably contains a propylene oxide adduct of bisphenol A or ethylene glycol.

The acid value of the amorphous polyester resin is, for example, 0 to 20 mgKOH/g. The weight average molecular weight of the amorphous polyester resin is preferably 5000 or more to further improve the durability and is preferably 50000 or less to improve fixability even in a low-temperature and low-humidity environment. The weight average molecular weight is more preferably 8000 to 15000.

### Aluminum Element

The toner needs to contain an aluminum element at the surface of the toner particle. Specifically, the toner particle preferably contains at least one compound containing aluminum element selected from aluminum chloride, polyaluminum chloride, aluminum sulfate, potassium aluminum sulfate, aluminum nitrate, aluminum lactate, and the like.

Means for incorporating the aluminum element into the surface of the toner particle is not particularly limited. For example, in the case of producing the toner particle by an emulsion coagulation method, it is possible to add a compound containing the aluminum element as an aggregating agent, and in the case of producing the toner particle by a pulverization method, it is possible to incorporate the aluminum element to the resin as a raw material in advance or to incorporate the aluminum element to the toner particle by adding the aluminum element at the time of melt-kneading the raw material.

In the case of producing the toner particle by a wet production method such as a polymerization method, it is also possible to incorporate the aluminum element to the raw material or to add the aluminum element through an aqueous medium in the production process.

### Binder Resin

As a binder resin for the toner, aside from polyester resins, a conventionally known resin can be jointly used with no particular limitation.

Specifically, it is possible to use a styrene-based copolymer such as polystyrene, a styrene-propylene copolymer, a styrene-vinyltoluene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-octyl methacrylate copolymer, a styrene-butadiene copolymer, a styrene-isoprene copolymer, a styrene-maleic acid copolymer, or a styrene-maleic acid ester copolymer, a polyacrylic acid ester, a polymethacrylic acid ester, polyvinyl acetate, or the like, and a plurality of these can be used in combination.

The binder resin preferably contains a styrene acrylic resin. The content percentage of the styrene acrylic resin in the binder resin is preferably 50 to 99 mass %, 60 to 98 mass %, or 80 to 97 mass %.

Examples of the styrene acrylic resin include homopolymers composed of the following polymerizable monomers, copolymers obtained by combining two or more thereof, and furthermore mixtures thereof.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;

(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, and 2-benzoyloxy ethyl (meth)acrylate, (meth)acrylonitrile, 2-hydroxyethyl (meth)acrylate, (meth)acrylic acid, and maleic acid;

vinyl ether-based monomers such as vinyl methyl ether and vinyl isobutyl ether; vinyl ketone-based monomers such as vinyl methyl ketone, vinyl ethyl ketone, and vinyl isopropenyl ketone;

polyolefins such as ethylene, propylene, and butadiene.

### Release Agent

In the toner, as a release agent, a known wax can be used.

Specific examples thereof include petroleum-based wax represented by paraffin wax, microcrystalline wax, or petrolatum and derivatives thereof, montan wax and derivatives thereof, hydrocarbon wax obtained by a Fischer-Tropsch method and derivatives thereof, polyolefin wax represented by polyethylene and derivatives thereof, and natural wax represented by carnauba wax or candelilla wax and derivatives thereof, and the derivatives also include oxides, block copolymers with a vinyl monomer, and graft modified products.

In addition, examples thereof include alcohols such as higher aliphatic alcohols; fatty acids such as stearic acid and palmitic acid and acid amides, esters, and ketones thereof, hydrogenated castor oils and derivatives thereof, plant wax, and animal wax. These can be used singly or can be used in combination.

Among these, in the case of using a polyolefin, hydrocarbon wax obtained by the Fischer-Tropsch method, or petroleum-based wax, there is a tendency that the developability or the transferability improves, which is preferable. The release agent is preferably paraffin wax. To this wax, an antioxidant may be added to an extent that the effect of the toner is not affected. In addition, from the viewpoint of a phase separation property with respect to the binder resin or the crystallization temperature, higher fatty acid esters such as behenyl behenate and dibehenyl sebacate can be suitably exemplified.

The content of the release agent is preferably from 1.0 part by mass to 30.0 parts by mass relative to 100.0 parts by mass of the binder resin.

### Coloring Agent

The toner particle may contain a coloring agent. As the coloring agent, a known pigment or dye can be used. From the viewpoint of excellent weather resistance, a pigment is preferable as the coloring agent.

Examples of a cyan-based coloring agent include copper phthalocyanine compounds and derivatives thereof, anthraquinone compounds, base dye lake compounds, and the like.

Specific examples thereof include the following: C.I. Pigment Blue 1, 7, 15, 15:1, 15:2, 15:3, 15:4, 60, 62, and 66.

Examples of a magenta-based coloring agent include condensed azo compounds, diketopyrrolopyrrole compounds, anthraquinone compounds, quinacridone compounds, basic dye lake compounds, naphthol compounds, benzimidazolone compounds, thioindigo compounds, perylene compounds, and the like.

Specific examples thereof include the following: C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of a yellow-based coloring agent include condensed azo compounds, isoindolinone compounds, anthraquinone compounds, azo metal complexes, methine compounds, allylamide compounds, and the like.

Specific examples thereof include the following: C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of a black coloring agent include coloring agents colored black using the yellow-based coloring agent, the magenta-based coloring agent, or the cyan-based coloring agent, carbon black, and magnetic bodies.

These coloring agents can be used singly or as a mixture, and these can be used in a solid solution state. The content of the coloring agent used is preferably from 1.0 part by mass to 20.0 parts by mass relative to 100.0 parts by mass of the binder resin. In the case of applying the production method using a magnetic body in an aqueous medium to be described below, it is also possible to perform a hydrophobic treatment for the purpose of stably incorporating the magnetic body into the resin.

### Method for Producing Toner

A method for producing a toner is not particularly limited, and a known method such as a pulverization method, a suspension polymerization method, a dissolution suspension method, an emulsion aggregation method, or a dispersion polymerization method can be used. Any production method can be applied to obtain the toner.

Hereinafter, a method for producing a toner particle by the emulsion aggregation method will be described as an example in detail.

### Dispersion Preparation Step

A binder resin particle dispersion is prepared, for example, in the following manner.

In a case where the binder resin is a resin other than vinyl-based resins such as a polyester resin, the resin is mixed with an aqueous medium dissolved in an ionic surfactant or a polymer electrolyte.

After that, this solution is heated to the melting point or softening point of the resin or higher to dissolve the resin, and the binder resin particle is dispersed in an aqueous medium containing the ionic surfactant using a dispersing machine having a strong shear force such as a homogenizer, thereby preparing the dispersion.

In a case where the binder resin is a homopolymer or copolymer (vinyl-based resin) of a vinyl-based monomer such as a styrene acrylic resin, emulsion polymerization, seed polymerization, or the like may be performed on the vinyl-based monomer in an ionic surfactant. This prepares a dispersion containing the particle of the vinyl-based resin dispersed in the aqueous medium containing the ionic surfactant.

Means for dispersion is not particularly limited, and examples thereof include known dispersing machines such as a rotary shear type homogenizer or a ball mill, sand mill, or dyno mill having a medium.

In addition, a phase inversion emulsification method may be used as a method for preparing the dispersion. The phase inversion emulsification method is a method in which the binder resin is dissolved in an organic solvent, a neutralizing agent or a dispersion stabilizer is added thereto as necessary, an aqueous solvent is added dropwise under stirring to obtain an emulsified particle, and the organic solvent in the resin dispersion is then removed, thereby obtaining an emulsified liquid. At this time, the order of the neutralizing agent or the dispersion stabilizer injected may be changed. The number average particle size of the binder resin particle is usually 1 μm or less and preferably 0.01 μm to 1.00 μm. When the number average particle size is 1.00 μm or less, the particle size distribution of a toner to be obtained in the end is suitable, and the generation of a free particle can be suppressed. In addition, when the number average particle size is within the above-described range, uneven distribution in the toner is reduced, dispersion in the toner becomes favorable, and a variation in performance and reliability becomes small.

Even in a case where the toner particle contains a crystalline polyester resin, it is possible to obtain a crystalline polyester resin particle dispersion by the above-described method.

In the emulsion aggregation method, a coloring agent particle dispersion can be used as necessary. The coloring agent particle dispersion contains at least a coloring agent particle dispersed in a dispersant. The number average particle size of the coloring agent particle is preferably 0.5 μm or less and more preferably 0.2 μm or less. When the number average particle size is 0.5 μm or less, it is possible to prevent the diffuse reflection of visible light, and it is easy to aggregate the binder resin particle and the coloring agent particle in an aggregation step. When the number average particle size is within the above-described range, uneven distribution in the toner is reduced, dispersion in the toner becomes favorable, and a variation in performance and reliability becomes small.

In the emulsion aggregation method, a wax particle dispersion can be used as necessary. The wax particle dispersion contains at least a wax particle dispersed in a dispersant. The number average particle size of the wax particle is preferably 2.0 μm or less and more preferably 1.0 μm or less. When the number average particle size is 2.0 μm or less, a deviation of the content of the wax between the toner particles is small, and the image stability over a long period of time becomes favorable. When the number average particle size is within the above-described range, uneven distribution in the toner is reduced, dispersion in the toner becomes favorable, and a variation in performance and reliability becomes small.

The combination of the coloring agent particle, the binder resin particle, and the wax particle is not particularly limited and can be freely selected as appropriate depending on the purpose. In addition to the above-described dispersions, other particle dispersions containing an appropriately selected particle dispersed in a dispersant may be further mixed therewith. The particle that is contained in the other particle dispersions is not particularly limited and can be selected as appropriate depending on the purpose, and examples thereof include an internal additive particle, a charge control agent particle, an inorganic particle, an abrasive particle, and the like. These particles may be dispersed in the binder resin particle dispersion or the coloring agent particle dispersion.

Examples of the dispersants that are contained in the binder resin particle dispersion, the coloring agent particle dispersion, the wax particle dispersion, and the other particle dispersions, and the like include aqueous media containing a polar surfactant and the like. Examples of the aqueous media include water such as distilled water and ion exchanged water, alcohols, and the like. These media may be used singly or two or more thereof may be jointly used. The content of the polar surfactant cannot be generally determined and can be selected as appropriate depending on the purpose.

Examples of the polar surfactant include anionic surfactants such as sulfate ester salt-based surfactants, sulfonate-based surfactants, phosphate ester-based surfactants, and soap-based surfactants; cationic surfactants such as amine salt-type surfactants and quaternary ammonium salt-type surfactants; and the like. Specific examples of the anionic surfactants include sodium dodecyl benzenesulfonate, sodium dodecyl sulfate, sodium alkylnaphthalenesulfonate, sodium dialkyl sulfosuccinate, and the like. Specific examples of the cationic surfactants include alkylbenzene dimethyl ammonium chloride, alkyltrimethyl ammonium chloride, distearyl ammonium chloride, and the like.

Among these, in the present disclosure, a sulfonate-based surfactant is preferably used as described above. These polar surfactants may be used singly or two or more thereof may be jointly used.

This polar surfactant and a non-polar surfactant can also be jointly used. Examples of the non-polar surfactant include nonionic surfactants such as polyethylene glycol-based surfactants, alkylphenol ethylene oxide adduct-based surfactants, and polyhydric alcohol-based surfactants and the like.

The content of the coloring agent particle is preferably 0.1 to 30 parts by mass relative to 100 parts by mass of the binder resin in an aggregated particle dispersion when an aggregated particle has been formed.

The content of the wax particle is preferably 0.5 to 25 parts by mass and more preferably 5 to 20 parts by mass relative to 100 parts by mass of the binder resin in the aggregated particle dispersion when the aggregated particle has been formed.

Furthermore, in order to control the chargeability of a toner to be obtained in more detail, a charging control particle and the binder resin particle may be added after the aggregated particle has been formed.

The particle sizes of the particles such as the binder resin particle and the coloring agent particle are measured using a laser diffraction/scattering particle size distribution measuring instrument LA-960V2 manufactured by Horiba, Ltd.

### Aggregation Step

The aggregation step of forming the aggregated particle is a step of forming the aggregated particle including the binder resin particle, and the coloring agent particle, the wax particle, and the like that are added as necessary in an aqueous medium containing the binder resin particle, and the coloring agent particle, the wax particle, and the like that are added as necessary.

The aggregated particle can be formed in the aqueous medium by, for example, adding a pH adjuster, an aggregating agent, and a stabilizer into the aqueous medium, mixing the components, and appropriately applying the temperature, mechanical power, or the like thereto.

Examples of the pH adjuster include ammonia, alkalis such as sodium hydroxide, and acids such as nitric acid and citric acid. Examples of the aggregating agent include monovalent metal salts such as sodium and potassium; divalent metal salts such as calcium and magnesium; trivalent metal salts such as iron and aluminum; and the like; and alcohols such as methanol, ethanol, and propanol.

Examples of the stabilizer include mainly polar surfactants themselves, aqueous media containing a polar surfactant, and the like. For example, in a case where the polar surfactant that is contained in each particle dispersion is anionic, a cationic stabilizer can be selected as the stabilizer.

The aggregating agent and the like are preferably added and mixed at a temperature equal to or lower than the glass transition temperature of a resin that is contained in the aqueous medium. When the aggregating agent and the like are mixed under this temperature condition, aggregation progresses in a stable state. The mixing can be performed using, for example, a known mixing device, homogenizer, mixer, or the like.

In addition, in the aggregation step, a dispersion containing an amorphous polyester resin is attached to the surface of the aggregated particle to form a coating layer (shell layer), whereby a toner particle having a core/shell structure in which the shell layer has been formed on the surface of a core particle can be obtained. That is, the toner particle preferably has a shell containing the amorphous polyester resin on the surface of the core particle. The amorphous polyester resin shell makes it easy for the amorphous polyester resin to be present at the surface of the toner particle. The core particle preferably contains a styrene acrylic resin. The amount of the shell is preferably 1.5 to 10 parts by mass and more preferably 2 to 6 parts by mass relative to 100 parts by mass of the core particle.

The aggregation step may be repeatedly performed stepwise in a plurality of installments.

### Fusion Step

A fusion step is a step of heating and fusing the resultant aggregated particle. Before the fusion step, a pH adjuster, a polar surfactant, a non-polar surfactant, and the like can be appropriately injected thereinto to prevent the fusion between the toner particles. The heating temperature can be the glass transition temperature of the resin that is contained in the aggregated particle (the glass transition temperature of the resin having the highest glass transition temperature in a case where two or more resins are contained therein) to the decomposition temperature of the resin.

Therefore, the heating temperature varies depending on the type of the resin in the binder resin particle and cannot be generally determined, but is generally from the glass transition temperature of the resin that is contained in the aggregated particle to 140° C. The heating can be performed using a known heating device or instrument.

As the fusion time, a short time is enough if the heating temperature is high, and a long time is required if the heating temperature is low. That is, the fusion time depends on the heating temperature and is generally from 30 minutes to 10 hours while the fusion time cannot be generally determined.

The toner particle obtained through each of the above-described steps is separated into solid and liquid according to a known method, and the toner particle is collected and then can be washed, dried, and the like under appropriate conditions.

### External Addition Step

A toner can be obtained by adding an inorganic fine particle such as a strontium titanate fine particle having a Si-containing protrusion portion at the surface to the resultant toner particle. Other external additives may be added thereto as necessary. The mixing time in an external addition step is preferably adjusted to a range of 5 minutes to 30 minutes and more preferably adjusted to a range of 8 minutes to 20 minutes from the viewpoint of the dispersibility of the external additives.

### Method for Measuring Each Physical Property

Next, a method for measuring each physical property will be described.

### Method for Separating Each Material From Toner

Each material can be separated from the toner using a difference in solubility of each material that is contained in the toner in the solvent.

First separation: The toner is dissolved in methyl ethyl ketone (MEK) at 23° C. to separate soluble components (the amorphous polyester resin and the styrene acrylic resin) and insoluble components (the crystalline polyester resin, the wax, the coloring agent, the inorganic fine particle, and the like).

Second separation: The insoluble components (the crystalline polyester resin, the wax, the coloring agent, the inorganic fine particle, and the like) obtained in the first separation are dissolved in MEK at 100° C. to separate soluble components (the crystalline polyester resin and the wax) and insoluble components (the coloring agent, the inorganic fine particle, and the like).

Third Separation: The soluble components (the crystalline polyester resin and the wax) obtained in the second separation are dissolved in chloroform at 23° C. to separate a soluble component (the crystalline polyester resin) and an insoluble component (wax).

Fourth separation: The soluble components (the amorphous polyester resin and the styrene acrylic resin) obtained in the first separation are dissolved in a mixed solution of methyl ethyl ketone (MEK) and toluene at 23° C. to separate a soluble component (the styrene acrylic resin) and an insoluble component (the amorphous polyester resin).

### Monomer Analysis of Amorphous Polyester Resin Component

Regarding the types of monomers of the amorphous polyester resin component, a sample of each resin component separated from the toner is analyzed using a pyrolysis GC/MS device under the following conditions. The mass spectrum of a component of a resin decomposed product that is generated at the time of pyrolyzing the resin at 550° C. to 700° C. is analyzed, thereby identifying the type of a constituent compound. Specific measurement methods are as follows.
Measuring instrument: “Voyager” (trade name, manufactured by Thermo Electron Corporation)
Pyrolysis temperature: 600° C.
Column: HP-1 (15 m×0.25 mm×0.25 μm)
Inlet: 300° C., Split: 20.0
Injection amount: 1.2 mL/min
Heating: 50° C. (4 min) to 300° C. (20° C./min)

### Method for Measuring Abundance Sp of Amorphous Polyester Resin at Surface of Toner Particle

The abundance Sp of the amorphous polyester resin at the surface of the toner particle is measured by an isolation method of the strontium titanate fine particle having a Si-containing protrusion portion at the surface, which will be described below, using the toner particle obtained by separating the inorganic fine particle from the toner.

Time-of-flight secondary ion mass spectrometry (TOF-SIMS) is used in the measurement. For the fragment ion measurement of the amorphous polyester resin, TRIFT-IV manufactured by ULVAC-PHI, Inc. is used.

Analysis conditions are as follows.
Sample adjustment: The toner particle is attached to an indium sheet
Primary ion: Au ion
Accelerating voltage: 30 kV
Charge neutralization mode: On
Measurement mode: Positive
Raster: 200 μm
Measurement time: 60 s

The total count number of mass numbers identified by the monomer analysis of the amorphous polyester resin is converted into the ion amount (secondary ion mass/secondary ion charge number (m/z)) according to the standard soft (Win Cadense) from ULVAC-PHI, Inc., and a value obtained by dividing the above-described value by the total ion amount counted in the measurement of the toner and multiplying the result by 100 is defined as the abundance Sp (%) of the amorphous polyester resin.

### Method for Quantifying Content Percentage Uᵢₛₒ of Monomer Unit Derived From Isophthalic Acid

Regarding the monomers identified by the monomer analysis of the amorphous polyester resin, the composition of the amorphous polyester resin is analyzed by NMR, whereby the composition percentage of each monomer can be obtained.

The composition analysis by NMR can be performed as follows.

The composition of the amorphous polyester resin is analyzed using nuclear magnetic resonance spectroscopy (¹H-NMR) [400 MHz, CDCl₃, temperature (60° C.)].
Measuring instrument: FT NMR instrument JNM-EX400 (manufactured by JEOL Ltd.)
Measurement frequency: 400 MHz
Pulse condition: 5.0 μs
Frequency range: 10500 Hz
Accumulation count: 64 times

In addition, the composition of the amorphous polyester resin is analyzed using nuclear magnetic resonance spectroscopy (¹³C-NMR) [400 MHz, CDCl₃ (TMS 0.05%), temperature (40° C.)].
Measuring instrument: FT NMR instrument JNM-EX400 (manufactured by JEOL Ltd.)
Measurement frequency: 400 MHz
Pulse condition: 5.0 μs
Frequency range: 10500 Hz
Accumulation count: 16 times

From the mass profile of the obtained secondary ion mass/secondary ion charge number (m/z), the monomer composition ratio of the monomer species identified by the above-described monomer analysis is obtained.

### Method for Measuring Content C_{Al} of Aluminum Element at Surface of Toner Particle

The content of a polyhydric metal is measured from an electron image of the cross section of the toner particle by the following method using a transmission electron microscope (TEM).

As a measurement sample, a sample obtained by mixing a visible light curing embedding resin (D-800, manufactured by Nisshin EM Co., Ltd.) and the toner particle, pressure-molding the mixture into a disk shape having a diameter of 7.9 mm and a thickness of 1.0±0.3 mm using a tablet molding machine under a 25° C. environment, and embedding the toner particle is used. The pressure molding is performed under conditions of 35 MPa and 60 seconds. A thin piece-like sample having a film thickness of 100 nm is cut out from this sample using an ultramicrotome equipped with a diamond blade (EM UC7: manufactured by Leica Microsystems) at a cutting speed of 0.6 mm/s.

This sample is expanded to a magnification of 200000 times using a transmission electron microscope (TEM) (JEM 2800 type: manufactured by JEOL Ltd.) under conditions of an accelerating voltage of 200 keV and an electron beam probe size of 1 mm, and the cross section of the toner particle is observed. A cross section having a major axis of the weight average particle size (D4) of the toner particle to be observed ±10% is observed.

Subsequently, for the resultant constituent elements of the cross-section of the toner particle, spectra are collected using energy-dispersed X-ray spectroscopy (EDS: NSS Thermo electron).

Mapping of the cross section of the toner is performed under the following conditions.

### STEM-EDS Element Mapping Image Acquisition Conditions

A STEM-EDS element mapping image is acquired in the same field of view as the SEI image observation field of view.
EDS detector: JED-2300 T dry SD100GV detector from JEOL Ltd. (detector element area: 100 mm²)
EDS analyzer: NORAN System7 manufactured by Thermo Fisher Scientific Inc.
Drift correction factor: 2
Dwell time: 30 μs
Accumulation count: 100 frames
X-ray count rate: 4000 to 10000 cps
Element mapping image size: 256×256 pixels

A quantitative map image was extracted from the collected spectral mapping data using a quantitative map mode in the measurement command of NORAN System7 described above. At that time, the set values were as follows.
Kernel size: 3×3
Quantitative map setting: High (slow)
Filter fit type: High precision (slow)

Next, 1000 pixels are extracted from the surface of the toner particle in a range of 5 nm in the vertical direction. EDS spectra of the extracted pixels are added together.

Quantitative analysis is performed by the Cliff-Lorimer method from the resultant spectrum, and the aluminum element content C_{Al} (atomic %) is calculated. The C_{Al} (atomic %) is the atomic weight fraction when all elements that are detected during the analysis are set to 100%.

The measurement is performed on the cross sections of 20 toner particles, and an arithmetic mean value is adopted.

### Method for Measuring Abundance S_{ST} (Area %) of Strontium Titanate Fine Particle Having Si-Containing Protrusion Portion at Surface

For the toner, an image was captured at a magnification of 40000 times using a scanning electron microscope (SEM) (S-4800, manufactured by Hitachi High-Tech Corporation) equipped with an EDX device (EMAX Evolution X-Max (80 mm²) manufactured by Horiba, Ltd.). 300 or more strontium titanate fine particles having a Si-containing protrusion portion at the surface are specified from one field of view based on the presence of Ti and Sr by EDX analysis. Observation was performed with the SEM at an accelerating voltage of 15 kV, an emission current of 20 μA, and WD of 15 mm, and the EDX analysis was performed under the same conditions for a detection time set to 60 minutes.

A criterion for determining whether or not a selected fine particle is a strontium titanate fine particle having a Si-containing protrusion portion at the surface is whether or not a Si-containing protrusion portion, which will be described below, is present.

For the specified strontium titanate fine particle having a Si-containing protrusion portion at the surface, the abundance S_{ST} (area %) of the strontium titanate fine particle having a Si-containing protrusion portion at the surface at the surface of the toner is obtained using an area analysis tool in image processing analysis software WinRoof (Mitani Corporation).

Method for Isolating Strontium Titanate Fine Particle Having Si-Containing Protrusion Portion at Surface

In the case of measuring the physical properties of the strontium titanate fine particle having a Si-containing protrusion portion at the surface, other external additives, and the toner particle from the toner to which the strontium titanate fine particle having a Si-containing protrusion portion at the surface has been externally added, it is possible to isolate and measure the strontium titanate fine particle having a Si-containing protrusion portion at the surface and the other external additives from the toner.

The strontium titanate fine particle having a Si-containing protrusion portion at the surface or the other external additives are removed by ultrasonically dispersing the toner in methanol and left to stand for 24 hours. The ultrasonic dispersion is performed for 60 minutes at a frequency of 20 kHz and an output of 30 W. The precipitated toner particle, and the strontium titanate fine particle having a Si-containing protrusion portion at the surface and the other external additives dispersed in a supernatant liquid are separated, collected, and sufficiently dried, whereby the toner particle can be isolated. In addition, the supernatant liquid is treated by centrifugation, whereby the strontium titanate fine particle having a Si-containing protrusion portion at the surface can be isolated.

Method for Measuring Number Average Particle Size of Si-Containing Protrusion Portions

The number average particle size of the primary particle of the Si-containing protrusion portions is measured using a transmission electron microscope (TEM) “JEM 2800” (manufactured by JEOL Ltd.). The strontium titanate fine particle separated by the above-described procedure can be used.

First, a measurement sample is adjusted. 1 ml of isopropanol is added to 5 mg of the strontium titanate fine particle to be measured and dispersed with an ultrasonic dispersing machine (ultrasonic washing machine) for 5 minutes. One drop of the dispersion was then dropped onto a microgrid with a support membrane (150 mesh) for TEM and dried, thereby preparing a measurement sample.

Next, an image is acquired with a transmission electron microscope (TEM) under the conditions of an accelerating voltage of 200 kV and a magnification at which protrusion portions in the visual field can be sufficiently measured (for example, 200000 to 1000000 times), and the particle sizes of 100 protrusion portions are randomly measured to obtain the number average particle size. The particle sizes are measured using image processing software “Image-Pro Plus ver. 4.0 (manufactured by Media Cybernetics Co., Ltd.).

The Si-containing protrusion portion is determined by performing the secondary electron shape image (SEI) observation and EDS mapping measurement of the strontium titanate fine particle separated by the above-described method using a transmission electron microscope (TEM) “JEM 2800” (manufactured by JEOL Ltd.). In the EDS mapping measurement, EDS mapping can be measured with high sensitivity using a silicon drift detector having a large detection element area. The conditions will be shown below.

### Shape Image Acquisition Conditions

Mode: STEM observation mode
Accelerating voltage: 200 kV
Magnification: 1,000,000 times
Probe size: 1 nm
Detector: Secondary electron detector (SEI detector)
SEI image size: 1024×1024 pixels

### STEM-EDS Element Mapping Image Acquisition Conditions

A STEM-EDS element mapping image is acquired in the same field of view as the SEI image observation field of view.
EDS detector: JED-2300T dry SD100GV detector from JEOL Ltd. (detector element area: 100 mm²)
EDS analyzer: NORAN System7 manufactured by Thermo Fisher Scientific Inc.
Drift correction factor: 2
Dwell time: 30 μs
Accumulation count: 100 frames
X-ray count rate: 4000 to 10000 cps
Element mapping image size: 256×256 pixels

A quantitative map image was extracted from the collected spectral mapping data using a quantitative map mode in the measurement command of NORAN System7 described above. At that time, the set values were as follows.
Kernel size: 3×3
Quantitative map setting: High (slow)
Filter fit type: High precision (slow)

First, a shape image of the strontium titanate fine particle is acquired. After that, EDS element quantitative mapping images of the Si element and the Sr element are each acquired at the same magnification from the same position, and these EDS element mapping images are overlapped. Regarding a portion where the Si mapping and the Sr mapping overlap, it is difficult to finely separate parts containing Si. On the other hand, in the outer peripheral portion of the strontium titanate fine particle, a region where only Si is mapped is present outside of a Sr mapping region, and it is thus possible to clearly confirm a portion containing Si. In the outer peripheral portion where Si being contained has been confirmed, a protrusion portion is determined from the shape image acquired previously. In protrusions that are observed in the outer peripheral portion containing Si, the valley parts at both ends of the protrusion are connected with a straight line, and when the distance between the apex of the protrusion and the straight line is 1 nm or more, the protrusion is regarded as the protrusion portion in the present application. In addition, the length of the straight line connecting the valley parts at both ends of the protrusion is regarded as the particle size of the protrusion portion.

### Measurement of Powder Specific Resistance Value of Strontium Titanate Fine Particle Having Si-Containing Protrusion Portion at Surface

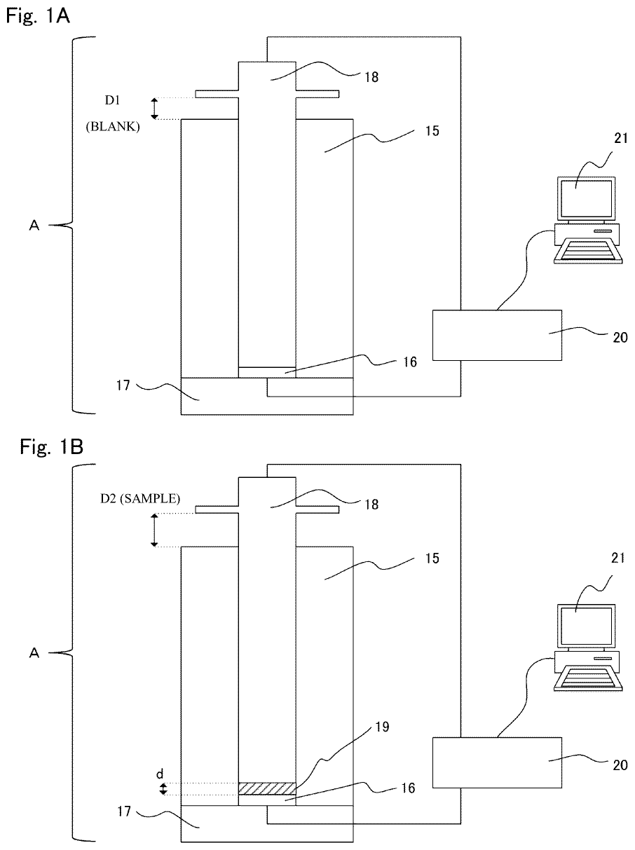

The resistance of the strontium titanate fine particle having a Si-containing protrusion portion at the surface is measured using a measuring instrument schematically shown in FIGS. 1A and 1B. In the case of measuring a sample, the sample is left to stand in an environment of a temperature of 23° C. and a humidity of 50% RH for 24 hours, and the resistance is then measured. A resistance measurement cell A is composed of a cylindrical PTFE resin container 15 having a hole with a cross-sectional area of 2.4 cm², a lower electrode (made of stainless steel) 16, a support base (made of a PTFE resin) 17, and an upper electrode (made of stainless steel) 18. The cylindrical PTFE resin container 15 is placed on the support base 17, 0.7 g of a sample 19 is loaded thereinto, the upper electrode 18 is placed on the loaded sample 19, and the thickness of the sample is measured. The thickness when the sample is not present beforehand is indicated by D1 (blank) (FIG. 1A), the thickness of the actual sample when loaded as much as 0.7 g is indicated by d, and the thickness when the sample is loaded is indicated by D2 (sample) (FIG. 1B), the thickness d of the sample is represented by the following equation.

$$d = D 2 ( sample ) - D 1 ( blank )$$

In addition, a voltage is applied between the electrodes, and a current flowing at that time is measured, whereby a specific resistance can be obtained. In the measurement, an electrometer 20 (Keithley 6517 manufactured by Tektronix, Inc.) and a control computer 21 are used. Regarding the measurement conditions, the contact area S between the sample and the electrode is set to 2.4 cm², and the load on the upper electrode is set to 230 g. Regarding the voltage application conditions, an IEEE-488 interface is used for the control between the control computer and the electrometer, and screening is performed by applying each voltage of 1 V, 2 V, 4 V, 8 V, 16 V, 32 V, 64 V, 128 V, 256 V, 512 V, and 1000 V for one second using an automatic range function of the electrometer.

At that time, the electrometer determines whether or not the application of a maximum of 1000 V (for example, 10000 V/cm as an electric field intensity in the case of a sample thickness of 1.00 mm) is possible, and in a case where of an overcurrent flows, “VOLTAGE SOURCE OPERATE” blinks. Then, the applied voltage is lowered, an applicable voltage is further screened, and the maximum value of the applied voltage is automatically determined. After that, the measurement is performed.

A resistance value is measured from a current value after one of the five voltages obtained by equally dividing the maximum voltage value by five is held for 30 seconds as each step. For example, in a case where the maximum applied voltage is 1000 V, voltages are applied in ascending order and then descending order at intervals of 200 V, which is ⅕ of the maximum applied voltage, such as 200 V (first step), 400 V (second step), 600 V (third step), 800 V (fourth step), 1000 V (fifth step), 1000 V (sixth step), 800 V (seventh step), 600 V (eighth step), 400 V (ninth step), and 200 V (tenth step), and a resistance value is measured from a current value after the voltage is held for 30 seconds in each step. Those are treated with the computer, whereby the electric field intensity and the specific resistance are calculated and plotted in a graph. A specific resistance at an electric field intensity of 1000 V/cm is read from the plot. The specific resistance and the electric field intensity can be obtained by the following equation:

$$Specific resistance ( Ω \cdot cm ) = ( applied voltage ( V ) / measured current ( A ) ) \times S ( {cm}^{2} ) / d ( cm )$$

$$Electric field intensity ( V / cm ) = applied voltage ( V ) / d ( cm )$$

### Measurement of Weight Average Particle Size (D4) of Toner Particle

The toner particle is measured with 25,000 effective measurement channels using a precision particle size distribution measuring instrument “Coulter Counter Multisizer 3” (registered trademark, manufactured by Beckman Coulter, Inc.) by a pore electrical resistance method provided with an 100 μm aperture tube and dedicated software “Beckman Coulter Multisizer 3 Version 3.51” (manufactured by Beckman Coulter, Inc.) attached for setting measurement conditions and analyzing measurement data, the measurement data is analyzed, and the weight-average particle size (D4) is calculated.

### Method for Measuring Bragg Angle Θ of Strontium Titanate Fine Particle Having Si-Containing Protrusion Portion at Surface

The Bragg angle θ of the inorganic fine particle is measured using a powder X-ray diffractometer “SmartLab” (sample horizontal strong X-ray diffractometer manufactured by Rigaku Holdings Corporation).

In addition, for the calculation of the Sb/Sa from the obtained peak, “PDXL2 (version 2.2.2.0)” of analysis software attached to the above-described instrument is used.

As a measurement sample, the toner or the toner from which the strontium titanate fine particle has been isolated is used, and the Bragg angle θ is measured by the following procedure. In the following example, the Bragg angle θ is measured with the produced strontium titanate fine particle.

### Preparation of Sample

The measurement sample is uniformly put into a Boro-silicate capillary (W. Muller GmbH) having a diameter of 0.5 mm and then measured.

### Measurement Conditions

Tube: Cu

Optical system: CBO-E

Sample stand: Capillary sample stand

Detector: D/tex Ultra 250 detector

Voltage: 45 kV

Current: 200 mA

Start angle: 10°

End angle: 90°

Sampling width: 0.02°

Speed measurement time set value: 10

IS: 1 mm

RS1: 20 mm

RS2: 20 mm
Attenuator: Open
Capillary rotation speed set value: 100

As other conditions, the initial set value of the instrument is used.

### Analysis

First, a peak separation treatment is performed on the obtained peak using software “PDXL2” attached to the instrument. Peak separation is achieved by executing optimization using a “split type Voigt function” that can be selected in PDXL, and the obtained integrated intensity value is used.

This determines the value of 2Θ for the diffraction peak top and the area thereof. The Sb/Sa is calculated from the peak area of a predetermined 2Θ value. At this time, in a case where the peak separation calculation result and the actually measured spectrum are significantly shifted, the calculation result and the actually measured spectrum are adjusted to match each other by a treatment such as manual setting of the baseline.

Method for Identifying and Quantifying Dodecylbenzenesulfonic Acid Component

A dodecylbenzenesulfonic acid component contained in the toner particle was measured using a mass spectrometer-added thermal desorption gas chromatography TRACE 2000 CG/MS, manufactured by ThermoQuest under the following conditions.
Extraction condition 120.0° C.
Sample amount 1.0 g
Column: 0.32 mm capillary column

For each peak in the obtained analysis results, a raw material-derived component of dodecylbenzenesulfonic acid was analyzed and identified from the mass spectrum.

Next, a plurality of concentrations after the dilution of the dodecylbenzenesulfonic acid were adjusted, and a calibration curve was created. Next, the dodecylbenzenesulfonic acid component was quantified from the peak height derived from the dodecylbenzenesulfonic acid component and the calibration curve in the analysis results.

### Method for Evaluating Adhesion Rate of Strontium Titanate Fine Particle Having Si-Containing Protrusion Portion at Surface

The adhesion rate of the strontium titanate fine particle having a Si-containing protrusion portion at the surface can be measured by the following method. The higher the value of the adhesion rate, the more difficult it is for the strontium titanate fine particle having a Si-containing protrusion portion at the surface to migrate to other members.

First, two types of samples (a toner before water washing and a toner after water washing) are prepared.
(i) Toner before water washing: A variety of toners prepared in Examples to be described below are used as they are.
(ii) Toner after water washing: 160 g of sucrose (manufactured by Kishida Chemical Co., Ltd.) is added to 100 mL of ion exchanged water and dissolved in hot water to prepare a sucrose concentrate. 31 g of the sucrose concentrate and 6 mL of CONTAMINON N (a 10 mass % aqueous solution of a neutral detergent for washing a precision measuring instrument having a pH of 7 composed of a nonionic surfactant, an anionic surfactant, and an organic builder, manufactured by Wako Pure Chemical Industries, Ltd.) are put into a centrifuge tube to prepare a dispersion.

1 g of the toner is added to this dispersion, and the lump of the toner is broken with a spatula or the like. The centrifuge tube is shaken in a shaker (AS-1N, AS ONE Corporation) at 5.8 s⁻¹ for 20 minutes. After the shaking, the solution is moved into a glass tube for a swing rotor (50 mL) and centrifuged with a centrifuge (FRONT LAB FLD2012 (manufactured by AS ONE Corporation) under conditions of 58.3 s⁻¹ and 30 minutes. Sufficient separation of the toner and the aqueous solution is visually confirmed, and the toner separated into the uppermost layer is collected with the spatula or the like. The aqueous solution containing the collected toner is filtered with a vacuum filter and then dried with a drier for one hour or longer, thereby producing a sample.

For these samples before and after water washing, the strontium titanate fine particle having a Si-containing protrusion portion at the surface is quantified using the intensity of a target element (for example, Sr) by wavelength dispersion type fluorescent X-ray analysis (XRF), and an adhesion rate is obtained.

As measurement samples, pellets obtained by putting 1 g of each of the toner after water washing and the toner before water washing into a dedicated aluminum ring for pressing, flattening the toner, and pressurizing the toner at 20 MPa for 60 seconds using a tablet molding compressor “BRE-32” (manufactured by Maekawa Testing Machine Mfg. Co., Ltd.) to mold the toner into a thickness of approximately 2 mm are used.

As measuring instruments, a wavelength dispersion type fluorescent X-ray analyzer “Axios” (manufactured by Malvern Panalytical Ltd.) and attached dedicated software “SuperQ ver. 4.0F” (manufactured by Malvern Panalytical Ltd.) for setting measurement conditions and analyzing measurement data are used. Rh is used as an anode of an X-ray tube, the measuring atmosphere is set to a vacuum, the measuring diameter (collimator mask diameter) is set to 10 mm, and the measuring time is set to 10 seconds. In addition, an element is detected with a proportional counter (PC) in the case of measuring a light element and with a scintillation counter (SC) in the case of measuring a heavy element. Measurement is performed under the above-described conditions, elements are identified on the basis of the peak positions of the obtained X-ray photons, and the concentrations thereof are calculated from the counting rates (unit: cps), which are the numbers of X-ray photons per unit time.

Regarding the migration rate from the toner, first, the intensity of an element in each of the toner before water washing and the toner after water washing is obtained by the above-described method. After that, the migration rate is calculated on the basis of the following equation:

$$Adhesion rate of strontium titanate fine particle having a Si - containing protrusion portion at surface = ( intensity of Sr element of toner after water washing ) / ( intensity of Sr element of toner before water washing ) \times 100$$

### EXAMPLES

Hereinafter, the present disclosure will be more specifically described with Examples, which do not limit the present disclosure. Unless particularly otherwise described, the numbers of parts in the following formulations indicate parts by mass.

### Production Example of Strontium Titanate Fine Particle A1 (Strontium Titanate Fine Particle A1 Having Si-Containing Protrusion Portion at Surface)

After an iron removal and bleaching treatment was performed on metatitanic acid produced by a sulfuric acid method, a 3 mol/L sodium hydroxide aqueous solution was added thereto to adjust the pH to 9.0, a desulfurization treatment was performed thereon, the metatitanic acid was neutralized with 5 mol/L hydrochloric acid up to a pH of 5.6, and filtration washing was performed thereon. Water was added to a washed cake to produce TiO₂, the TiO₂ was made into a 1.90 mol/L slurry, hydrochloric acid was then added thereto to adjust the pH to 1.4, and a peptization treatment was performed thereon.

The desulfurized and peptized metatitanic acid was made into TiO₂, 1.90 mol of the TiO₂ was collected and injected into a 3 L reaction vessel. To the peptized metatitanic acid slurry, 2.185 mol of a strontium chloride aqueous solution was added so that SrO/TiO₂ (molar ratio) reached 1.15, and the TiO₂ concentration was then adjusted to 1.039 mol/L.

Next, a sodium silicate aqueous solution was prepared so that the amount of Si added reached 5.0 mol % relative to strontium and heated to 90° C. while being stirred and mixed, and 440 mL of a 10 mol/L sodium hydroxide aqueous solution was added thereto under ultrasonic vibration over 55 minutes.

After that, the sodium silicate aqueous solution was continuously stirred at 95° C. for 45 minutes, then, injected into ice water, and quenched to terminate the reaction.

The reaction slurry was heated up to 70° C., 12 mol/L of hydrochloric acid was added thereto until the pH reached 5.0, the slurry was continuously stirred for one hour, and a resultant precipitate was decantation-washed. After separation by filtration, the precipitate was dried in the atmosphere at 120° C. for eight hours. Subsequently, 300 g of a dried product was injected into a dry particle composition device (manufactured by Hosokawa micron corporation, NOBILTA NOB-130). The dried product was treated at a treatment temperature of 30° C. for 10 minutes with a rotary treatment blade at 90 m/sec. Furthermore, hydrochloric acid was added to the dried product until the pH reached 0.1, and the dried product was continuously stirred for one hour. A resultant precipitate was decantation-washed. A slurry containing the precipitate was adjusted to 40° C., and hydrochloric acid was added thereto to adjust the pH to 2.5.

Next, 13 mass % of propyltrimethoxysilane was stirred and mixed for two hours, then, added to the solid content, continuously stirred and held for 10 hours. A 5N sodium hydroxide solution was added thereto to adjust the pH to 6.5, stirring was continued for one hour, then, filtration and washing were performed, and a resultant cake was dried in the atmosphere at 120° C. for eight hours. A resultant strontium titanate fine particle was regarded as a strontium titanate fine particle A1 having a Si-containing protrusion portion at the surface.

At the surface of the strontium titanate fine particle A1 having a Si-containing protrusion portion at the surface, a protrusion portion in which a part of silica particle had been embedded or which had been formed by the fixation of the silica particle was present. The particle size of the silica particle forming the protrusion portion was 4 nm.

### Production Examples of Strontium Titanate Fine Particles A2 to A10

Strontium titanate fine particles A2 to A10 were obtained by changing the amount of the sodium silicate aqueous solution, the amount of a surface treatment (the amount of propyltrimethoxysilane), and the treatment time in the dry particle composition device as shown in Table 1 in the production example of the strontium titanate fine particle A1.

At the surfaces of the strontium titanate fine particles A2 to A9 (the strontium titanate fine particles A2 to A9 having a Si-containing protrusion portion at the surface), a protrusion portion in which a part of silica particle had been embedded or which had been formed by the fixation of the silica particle was present. The particle sizes of the silica particle forming the protrusion portions were less than 5 nm.

At the surface of the strontium titanate fine particle A10, no Si-containing protrusion portions were present.

### Production Example of Amorphous Polyester Resin D1

100 parts by mass of a mixture in which raw material monomers were mixed in charge fractions shown in Table 2 and 0.55 parts by mass of tin (II) 2-ethylhexanoate as a catalyst were put into a 6 liter four-neck flask equipped with a nitrogen introduction tube, a dehydration tube, a stirrer, and a thermocouple and reacted under a nitrogen atmosphere at 200° C. for six hours. The reaction was performed under reduced pressure of 40 kPa and continued until the weight average molecular weight (Mw) reached 12000. A resultant amorphous polyester resin is regarded as an amorphous polyester resin D1.

### Production Examples of Amorphous Polyester Resins D2 to D5

Amorphous polyester resins D2 to D5 were obtained in the same manner as the production example of the amorphous polyester resin D1, except that the raw material monomers were changed as shown in Table 2.

### Amorphous Polyester Resin Particle Dispersions D1 to D5

The amorphous polyester resin D1 was transported in a molten state to CAVITRON CD1010 (manufactured by Eurotec Limited) at a rate of 100 g per minute. At the same time, a separately prepared ammonia water having a concentration of 0.37 mass % was transported to the CAVITRON CD1010 at a rate of 0.1 liters per minute while being heated to 120° C. in a heat exchanger. The CAVITRON CD1010 was operated under conditions of a rotor rotation speed of 60 Hz and a pressure of 5 kg/cm², and a resin particle dispersion containing the resin particles of the amorphous polyester resin having a volume average particle size of 169 nm dispersed therein was obtained. Ion exchanged water was added to the resin particle dispersion, and the amount of the solid content was adjusted to 20 mass %, thereby producing an amorphous polyester resin particle dispersion D1.

In addition, amorphous polyester resin particle dispersions D2 to D5 were obtained by the same method except that the amorphous polyester resin D1 was changed to D2 to D5.

### Production Example of Toner Particle 1

### Preparation of Styrene Acrylic Resin Particle Dispersion

Styrene: 75 parts
n-Butyl acrylate: 25 parts

A solution containing 1.0 part of an anionic surfactant (DOWFAX manufactured by Dow Inc.) dissolved in 60 parts of ion exchanged water was added to a solution obtained by mixing and dissolving the above-described materials, and dispersed and emulsified in a flask to prepare an emulsion of the monomers. Subsequently, 2.0 parts of sodium dodecylbenzenesulfonate was dissolved in 90 parts of ion exchanged water, 2.0 parts of the emulsion of the monomers was added thereto, and 10 parts of ion exchanged water containing 1.0 part of ammonium persulfate dissolved therein was injected thereinto.

After that, the remainder of the emulsion of the monomers was injected thereinto over three hours, nitrogen substitution in the flask was performed, the solution in the flask was heated up to 65° C. under stirring, and emulsion polymerization was continued for five hours, and a styrene acrylic resin particle dispersion was obtained. The amount of the solid content in the styrene acrylic resin particle dispersion was adjusted to 20 mass % by adding ion exchanged water thereto.

### Preparation of Coloring Agent Particle Dispersion

35 parts of a cyan pigment (C.I. Pigment Blue 15:3 manufactured by Dainichiseika Color & Chemicals Mfg. Co., Ltd.)
2.0 parts of sodium dodecylbenzenesulfonate
250 parts of ion exchanged water

The above materials were mixed, dissolved, and dispersed for approximately one hour using a high-pressure impact type dispersing machine ULTIMIZER (HJP30006 manufactured by Sugino Machine Limited) to obtain a coloring agent particle dispersion. The volume average particle size D50v of the particle in this coloring agent particle dispersion was 150 nm. After that, the concentration of the solid content was adjusted to 20 mass % by adding ion exchanged water thereto.

### Preparation of Release Agent Particle Dispersion

200 parts of paraffin wax (HNP-9, manufactured by Nippon Hinwax)
10.0 parts of sodium dodecyl benzenesulfonate
20.0 parts of ion exchanged water

The above materials were mixed together, a release agent was dissolved at an internal liquid temperature of 120° C. with a pressure discharge type homogenizer (GAULIN homogenizer manufactured by Gaulin Co., Ltd.), then dispersed at a dispersion pressure of 5 MPa for 120 min and subsequently at 40 MPa for 360 min, and cooled, thereby obtaining a dispersion. Ion exchanged water was added thereto to adjust the amount of the solid content to 20 mass %, and this dispersion was regarded as a release agent particle dispersion.

### Preparation of Crystalline Polyester Resin Particle Dispersion

1,10-dodecanedioic acid: 225 parts
1,6-hexandiol: 143 parts

The above-described materials were charged into a reaction vessel equipped with a stirring device, a nitrogen introduction tube, a temperature sensor, and a distillation tower, the temperature was raised up to 160° C. over one hour, and 0.8 parts by mass of dibutyltin oxide was injected thereinto. The temperature was further raised up to 180° C. over six hours while water being generated was distilled away, and a dehydration condensation reaction was continued for five hours while the temperature was maintained at 180° C. After that, the temperature was gradually raised up to 230° C. under reduced pressure, and the components were stirred for two hours while the temperature was maintained at 230° C. After that, a reaction product was cooled. After the cooling, solid and liquid were separated, and the solid content was dried, thereby obtaining a crystalline polyester resin.
Crystalline polyester resin: 100 parts
Methyl ethyl ketone: 40 parts
Isopropyl alcohol: 30 parts
10% ammonia aqueous solution: 6 parts

The above-described materials were added to a 3-liter reaction vessel equipped with a capacitor, a thermometer, a water dripping device, and a jacket with an anchor wing (BJ-30N manufactured by Tokyo Rikakikai Co., Ltd.), and the resin was dissolved while being stirred and mixed at 100 rpm while the materials were maintained at 80° C. in a water circulation type constant temperature bath. After that, the water circulation type constant temperature bath was set to 50° C., and a total of 400 parts of ion exchanged water kept warm at 50° C. was added dropwise thereto at a rate of 7 parts by mass per minute to invert the phase, thereby obtaining an emulsion. 576 parts by mass of the resultant emulsion and 500 parts by mass of ion exchanged water were put into a 2-liter eggplant flask and set in an evaporator (manufactured by Tokyo Rikakikai Co., Ltd.) equipped with a vacuum control unit through a trap sphere. The eggplant flask was warmed in a 60° C. hot water bath while being rotated, and the pressure was reduced to 7 kPa while attention was paid to bumping to remove the solvent. The volume average particle size D50v of the resin particle in this dispersion was 185 nm. After that, ion exchanged water was added thereto, thereby obtaining a crystalline polyester resin particle dispersion having a solid content concentration of 22.1 mass %.

### Production of Toner Particle

375 parts of styrene acrylic resin particle dispersion
75 parts of coloring agent particle dispersion
15 parts of release agent particle dispersion
33.9 parts of crystalline polyester resin particle dispersion
750 parts of ion exchanged water
3.2 parts of sodium dodecylbenzenesulfonate

The above-described materials were put into a 3-liter reaction vessel equipped with a thermometer, a pH meter, and a stirrer as materials for forming a core portion, the pH was adjusted to 3.0 by adding 1.0% nitric acid thereto at a temperature of 25° C., 100 parts of an aluminum chloride aqueous solution having a concentration of 2.0 mass % was added thereto as an aggregating agent while the materials were dispersed with a homogenizer (ULTRA-TURRAX T50 manufactured by IKA) at 5,000 rpm, and the materials were dispersed for six minutes.

After that, a mixed liquid was heated up to 53° C. using a stirring blade in a water bath for heating while the rotation speed was appropriately adjusted so that the mixed liquid was stirred. The volume average particle size of the formed aggregated particle was appropriately confirmed with Coulter Multisizer III, the temperature was held when the volume average particle size reached 5.0 μm, and 18.75 parts of the amorphous polyester resin particle dispersion 1 was injected thereinto over five minutes as a material for forming a shell layer. After that, the mixed liquid was held at 50° C. for 30 minutes, the temperature was then raised up to 90° C. while the pH was adjusted to 9.0, and the mixed liquid was held at 90° C.

After that, the pH at 90° C. was adjusted to 5.0 by adding hydrochloric acid thereto, and the mixed liquid was further stirred for 30 minutes. Furthermore, a 0.9 mol/L-Na₂CO₃ aqueous solution was injected thereinto, the pH was adjusted to 5.5, and the mixed liquid was held for 30 minutes. After that, the mixed liquid was cooled to 25° C., filtered, separated into solid and liquid, and then washed with ion exchanged water. After the end of the washing, the mixed liquid was dried using a vacuum drier, thereby obtaining a toner particle 1 having a weight average particle size of 7.3 μm.

### Production Example of Toner 1

The strontium titanate fine particle A1 (0.50 parts) and a silica fine particle (RY200 manufactured by Nippon Aerosil Co., Ltd.) (0.8 parts) were externally added to and mixed with the toner particle 1 (100.0 parts) with FM10C (manufactured by Nippon Coke & Engineering Co., Ltd.). Regarding the external addition conditions, an A0 blade was used as a lower blade, the interval of a deflector with the wall was set to 20 mm, the amount of the toner particle charged was set to 2.0 kg, the rotation speed was set to 66.6 s⁻¹, the external addition time was set to 10 minutes, the temperature of cooling water was set to 20° C., and the flow rate thereof was set to 10 L/min.

After that, the particles were sieved with a mesh having an opening size of 200 μm, thereby obtaining a toner 1.

### Production Examples of Toners 2 to 37

Toners 2 to 37 were obtained in the same manner as in the production example of the toner 1 except that combinations of the type and number of parts of the strontium titanate fine particle added, the type and number of parts of the amorphous polyester resin added, the number of parts of the crystalline polyester resin particle dispersion added, the concentration of the aluminum chloride added, and the type of the surfactant were changed as shown in Table 3.

### Examples 1 to 34 and Comparative Examples 1 to 3

The following evaluations were performed using the toners 1 to 37.

At the time of actual evaluations, the process speed of HP LaserJet Enterprise M609dn was modified to 410 mm/see and used.

In addition, as evaluation paper, Vitality (manufactured by Xerox Corporation, basis weight of 75 g/m², letter size) was used.

### Evaluation of Image Streaks

An image streak is an approximately 0.5 mm vertical streak that is generated by the break of a toner due to friction in a cartridge during long-term printing and is an image defect that is likely to be observed at the time of outputting a full halftone image.

As an image forming device, a modified LBP712Ci (manufactured by Canon Inc.) was used. The process speed of the main body was modified to 250 mm/sec. In addition, necessary adjustments for enabling image formation under this condition were made. Also, the toner was removed from a black cartridge and a cyan cartridge, and instead, each of the cartridges was filled with 50 g of a toner to be evaluated. The amount of the toner loaded was set to 1.0 mg/cm².

Image streaks during continuous use in a low-temperature and low-humidity environment (10° C., 10% RH) were evaluated. As an evaluation paper, XEROX4200 paper (manufactured by XEROX Corporation, (75 g/m²) was used.

In the low-temperature and low-humidity environment (10° C./10% RH), 20000 prints of an E-letter image for which the printing rate was 1% were output by intermittently and continuously outputting two prints every four seconds, 50% halftone images were then output over the entire surfaces, the presence or absence of a streak was observed, and evaluation ranks were given to image streaks. The evaluation results are shown in Table 4.

### Evaluation Criteria of Image Streaks

A: No streak or toner mass is generated.
B: There are no spotted streaks, but there are small toner masses at one or two places.
C: There are one or two spotted streaks or three or four small toner masses at an end portion.
D: There are one or two spotted streaks or five or six small toner masses over the entire surface

### Evaluation of Image Density Difference

For image evaluation of negative ghost, a band of a solid black image was output as much as one round of a developing sleeve in a low-temperature and low-humidity environment (10° C./10% RH), and a halftone image was then output.

In an evaluation method, a difference in reflection density measured with a Macbeth density reflectometer in a second round of the developing sleeve between a place where the solid black image had been formed in the first round (black print portion) and a place where the solid black image was not formed (non-image portion) in one print image was calculated as follows. In the image appearing in the second round of the developing sleeve, the image density in a portion that had been the black print portion in the first round of the developing sleeve is lower than the image density in a portion that had been the non-image portion in the first round of the developing sleeve, and a pattern form that had appeared in the first round is likely to appear as it is. The density difference herein was evaluated by a reflection density difference.

$$“ Reflection density difference ” = \{ reflection density ( reflection density of image in portion that has been non - image portion in first round of developing sleeve ) \} - \{ reflection density ( reflection density of image in portion that has been black print portion in first round of developing sleeve ) \}$$

The smaller the reflection density difference, the higher the image quality is evaluated to be. The evaluation results obtained by evaluating the reflection density difference by the following criteria are shown in Table 4.

### Evaluation Criteria

A: At least 0.00 and less than 0.10
B: At least 0.10 and less than 0.15
C: At least 0.15 and less than 0.20
D: 0.20 or more

### Method for Measuring Complex Elastic Modulus G* (50° C.) of Toner

The hardness of the toner is evaluated by the complex elastic modulus G* at 50° C. (50° C.). The larger the value of G* at 50° C., the less the generation of a streak is in the toner even in long-term durability evaluation with a high-speed machine. As a measuring instrument, a rotating flat plate type rheometer “ARES” (manufactured by TA Instruments) is used.

As a measurement sample, a sample obtained by weighing 0.1 g of the toner and press-molding the toner into a disk shape having a diameter of 8.0 mm and a thickness of 1.5±0.3 mm using a tablet molding machine under an environment of room temperature (25° C.) is used.

The sample was mounted on a parallel plate having a diameter of 8.0 mm, the temperature is raised from room temperature (25° C.) to 100° C. for five minutes, and the sample is held for three minutes and cooled to 25° C. over 10 minutes. After that, the sample is held at 25° C. for 30 minutes, and the measurement is then started. At this time, the sample is set so that the initial normal force reaches zero. In addition, as described below, the effect of the normal force can be canceled using an automatic tension adjustment (Auto Tension Adjustment ON) in the subsequent measurement. The measurement is performed under the following conditions.
(1) A parallel plate having a diameter of 8.0 mm is used.
(2) Frequency: Set to 1 Hz.
(3) The initial applied strain value (Strain) is set to 0.05%.
(4) The measurement is performed in a temperature range of 25° C. to 60° C. at a temperature rise rate (Ramp Rate) of 2.0 [° C./minute]. The measurement is performed under the following automatic adjustment mode setting conditions. The measurement is performed in an automatic strain adjustment mode (Auto Strain).
(5) The maximum strain (Max Applied Strain) is set to 20.0%.
(6) The maximum torque (Max Allowed Torque) is set to 200.0 [g·cm], and the minimum torque (Min Allowed Torque) is set to 0.2 [g·cm].
(7) The Strain Adjustment is set to 20.0% of the Current Strain. In the measurement, an automatic tension adjustment mode (Auto Tension) is employed.
(8) The Auto Tension Direction is set to Compression.
(9) The Initial Static Force is set to 10 g, and the automatic tension sensitivity (Auto Tension Sensitivity) is set to 10.0 g.
(10) As the operating condition of the automatic tension (Auto Tension), the Sample Modulus is set to 1.00×10⁶ Pa or more.

The complex elastic modulus G* at 50° C. when measured at a frequency of 1 Hz under the above-described conditions was obtained.

### Evaluation of Charging Leakage in Low-Temperature and Low-Humidity Environment

An evaluation toner and a predetermined carrier (standard carrier of the Image Society of Japan, spherical carrier N-01 having a surface-treated ferrite core) were left to stand for 24 hours or longer in a low-temperature and low-humidity environment of 10° C./10% RH. Next, 9.5 g of the carrier and 0.5 g of the toner were put into a 100 mL-capacity plastic bottle with a lid and shaken for 300 seconds with a shaker (YS(26) LD manufactured by Yayoi Chemical Industry Co., Ltd.) at a speed of four times of reciprocation per second, and a developer composed of the toner and the carrier was charged.

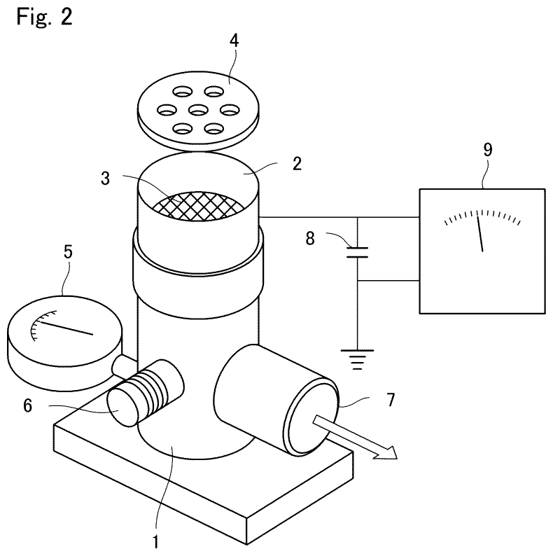

Next, the frictional charge amount was measured in a device for measuring the frictional charge amount shown in FIG. 2. Approximately 0.5 to 1.5 g of the developer was put into a metal measurement container 2 having a 500 mesh screen 3 at the bottom, and the container was closed with a metal lid 4. The mass of the entire measurement container at this time was indicated by W1 (g). Next, in a suction machine 1 (at least a portion in contact with the measurement container 2 was an insulator), the toner was suctioned from a suction port 7, and an air flow control valve 6 was adjusted to set the pressure of a vacuum gauge 5 to 250 mmAq. The toner was suctioned for two minutes in this state and removed by suction. The potential of an electrometer 9 at the end of the suction is indicated by V (volts). Here, 8 indicates a capacitor, the capacity is indicated by C (μF), and the entire measurement container after the suction was weighed and indicated by W2 (g). The frictional charge amount of this toner is calculated as in the following equation.

$$Frictional charge amount ( mC / kg ) of sample = C \times V / ( W 1 - W 2 )$$

The developer was further left to stand in the shaker for 300 seconds, and the same measurement was performed.

The smaller the ratio of the frictional charge amount after standing to before standing, the better the leakage is. The charging leakage was evaluated by the following evaluation criteria based on the value of (frictional charge amount after standing)/(frictional charge amount before standing)×100.

### Evaluation Criteria

A: Less than 50%
B: At least 50% and less than 60%
C: At least 60% and less than 70%
D: At least 70% and less than 80%

Excellent charging leakage in this evaluation indicates that electrons are easily transferred even in a low-temperature and low-humidity environment. When electrons are easily transferred, the difference in charging between the first round and second round of the sleeve in a thin density evaluation becomes small, and a thin density is thus less likely to occur.

In Examples 1 to 34, favorable results were obtained in all of the evaluation items. On the other hand, in Comparative Examples 1 to 3, the results were poorer than those of Examples in the evaluation item of the image density difference. In addition, in Comparative Example 1, the result was poor compared with those in Examples in the evaluation of image streaks.

The above-described results show that the present disclosure makes it possible to provide a toner that achieves a stable image density even in a low-temperature and low-humidity environment.

TABLE 1

| | | Amount of sodium | Amount of | | Powder | |
|---|---|---|---|---|---|---|
| | | silicate aqueous | surface | Treatment | specific | |
| | | solution added | treatment | time | resistance | |
| | | (mol %) | (mass %) | (min) | (Ωcm) | Sb/Sa |
| Strontium | A1 | 5.0 | 13 | 10 | 1.1 × 10¹⁰ | 2.02 |
| titanate fine | A2 | 5.0 | 13 | 15 | 1.1 × 10¹⁰ | 1.81 |
| particle | A3 | 5.0 | 13 | 7 | 1.1 × 10¹⁰ | 2.20 |
| | A4 | 5.0 | 13 | 17 | 1.1 × 10¹⁰ | 1.78 |
| | A5 | 5.0 | 13 | 6 | 1.1 × 10¹⁰ | 2.33 |
| | A6 | 5.0 | 8 | 10 | 1.1 × 10⁹ | 2.02 |
| | A7 | 5.0 | 23 | 10 | 9.0 × 10¹⁰ | 2.02 |
| | A8 | 5.0 | 7 | 10 | 8.0 × 10⁸ | 2.02 |
| | A9 | 5.0 | 25 | 10 | 1.2 × 10¹¹ | 2.02 |
| | A10 | 0.0 | 13 | 10 | 1.15 × 10¹⁰ | 2.02 |

TABLE 2

| | Monomer composition:charged (molar ratio) | | | | |
|---|---|---|---|---|---|
| | Acid | | Alcohol | | |
| Polyester | Terephthalic | Isophthalic | Bisphenol A | Ethylene | |
| resin | acid | acid | (PO adduct) | glycol | Uᵢₛₒ |
| D1 | 2 | 43 | 30 | 18 | 96 |
| D2 | 4 | 40 | 30 | 18 | 91 |
| D3 | 9 | 36 | 30 | 18 | 80 |
| D4 | 18 | 27 | 30 | 18 | 60 |
| D5 | 20 | 25 | 30 | 18 | 56 |

TABLE 3

| | | | | | | | Aluminum | | | | | | |
|---|---|---|---|---|---|---|---|---|---|---|---|---|---|
| | | TiSr fine | | APES | | CPES | chloride | | | | | | |
| | | particle A | | dispersion | | dispersion | Concentration | | | | | | Adhesion |
| Example | Toner | | Number | | Number | Number of | added | | | | | S_{ST}/ | rate |
| No | No. | NO. | of parts | NO. | of parts | parts | (%) | Surfactant | Sₚ | S_{ST} | C_{Al} | C_{Al} | (%) |
| 1 | 1 | 1 | 0.50 | 1 | 18.75 | 33.9 | 2.00 | SDBS | 80 | 30.0 | 0.1 | 300 | 95 |
| 2 | 2 | 1 | 0.30 | 1 | 15.00 | 33.9 | 0.10 | SDBS | 72 | 13.0 | 0.005 | 2600 | 92 |
| 3 | 3 | 1 | 0.20 | 1 | 11.25 | 10.2 | 0.08 | SDBS | 61 | 5.0 | 0.003 | 1667 | 90 |
| 4 | 4 | 1 | 0.60 | 1 | 22.50 | 50.9 | 9.80 | SDBS | 85 | 38.0 | 0.49 | 78 | 92 |
| 5 | 5 | 1 | 0.75 | 1 | 26.25 | 67.9 | 10.20 | SDBS | 90 | 43.0 | 0.98 | 44 | 90 |
| 6 | 6 | 1 | 0.50 | 1 | 18.75 | 33.9 | 2.00 | BuNSS | 80 | 30.0 | 0.1 | 300 | 95 |
| 7 | 7 | 1 | 0.50 | 1 | 18.75 | 3.39 | 2.00 | SDBS | 80 | 30.0 | 0.1 | 300 | 95 |
| 8 | 8 | 1 | 0.50 | 1 | 18.75 | — | 2.00 | SDBS | 80 | 30.0 | 0.1 | 300 | 95 |
| 9 | 9 | 1 | 0.50 | 2 | 18.75 | 33.9 | 2.00 | SDBS | 80 | 30.0 | 0.1 | 300 | 93 |
| 10 | 10 | 1 | 0.50 | 3 | 18.75 | 33.9 | 2.00 | SDBS | 80 | 30.0 | 0.1 | 300 | 92 |
| 11 | 11 | 1 | 0.50 | 4 | 18.75 | 33.9 | 2.00 | SDBS | 80 | 30.0 | 0.1 | 300 | 91 |
| 12 | 12 | 1 | 0.50 | 5 | 18.75 | 33.9 | 2.00 | SDBS | 80 | 30.0 | 0.1 | 300 | 89 |
| 13 | 13 | 2 | 0.50 | 1 | 18.75 | 33.9 | 2.00 | SDBS | 80 | 30.0 | 0.1 | 300 | 89 |
| 14 | 14 | 3 | 0.50 | 1 | 18.75 | 33.9 | 2.00 | SDBS | 80 | 30.0 | 0.1 | 300 | 88 |
| 15 | 15 | 4 | 0.50 | 1 | 18.75 | 33.9 | 2.00 | SDBS | 80 | 30.0 | 0.1 | 300 | 81 |
| 16 | 16 | 5 | 0.50 | 1 | 18.75 | 33.9 | 2.00 | SDBS | 80 | 30.0 | 0.1 | 300 | 82 |
| 17 | 17 | 6 | 0.50 | 1 | 18.75 | 33.9 | 2.00 | SDBS | 80 | 30.0 | 0.1 | 300 | 95 |
| 18 | 18 | 7 | 0.50 | 1 | 18.75 | 33.9 | 2.00 | SDBS | 80 | 30.0 | 0.1 | 300 | 95 |
| 19 | 19 | 8 | 0.50 | 1 | 18.75 | 33.9 | 2.00 | SDBS | 80 | 30.0 | 0.1 | 300 | 95 |
| 20 | 20 | 9 | 0.50 | 1 | 18.75 | 33.9 | 2.00 | SDBS | 80 | 30.0 | 0.1 | 300 | 95 |
| 21 | 21 | 1 | 0.45 | 1 | 18.75 | 33.9 | 2.00 | SDBS | 80 | 25.0 | 1.2 | 21 | 91 |
| 22 | 22 | 1 | 0.80 | 1 | 18.75 | 33.9 | 2.00 | SDBS | 80 | 44.0 | 0.0018 | 24444 | 95 |
| 23 | 23 | 1 | 0.45 | 1 | 18.75 | 33.9 | 2.00 | SDBS | 80 | 25.0 | 1.3 | 19 | 85 |
| 24 | 24 | 1 | 0.80 | 1 | 18.75 | 33.9 | 2.00 | SDBS | 80 | 44.0 | 0.0017 | 25882 | 91 |
| 25 | 25 | 1 | 0.15 | 1 | 18.75 | 33.9 | 2.00 | SDBS | 80 | 3.1 | 0.1 | 31 | 95 |
| 26 | 26 | 1 | 0.90 | 1 | 18.75 | 33.9 | 2.00 | SDBS | 80 | 49.0 | 0.1 | 490 | 92 |
| 27 | 27 | 1 | 0.10 | 1 | 18.75 | 33.9 | 2.00 | SDBS | 80 | 2.8 | 0.1 | 28 | 95 |
| 28 | 28 | 1 | 1.00 | 1 | 18.75 | 33.9 | 2.00 | SDBS | 80 | 52.0 | 0.1 | 520 | 85 |
| 29 | 29 | 1 | 0.50 | 1 | 18.75 | 33.9 | 0.05 | SDBS | 80 | 30.0 | 0.0012 | 25000 | 96 |
| 30 | 30 | 1 | 0.50 | 1 | 18.75 | 33.9 | 29.00 | SDBS | 80 | 30.0 | 1.9 | 16 | 91 |
| 31 | 31 | 1 | 0.50 | 1 | 18.75 | 33.9 | 0.03 | SDBS | 80 | 30.0 | 0.0008 | 37500 | 96 |
| 32 | 32 | 1 | 0.50 | 1 | 18.75 | 33.9 | 30.00 | SDBS | 80 | 30.0 | 2.1 | 14 | 85 |
| 33 | 33 | 1 | 0.50 | 1 | 7.50 | 33.9 | 2.00 | SDBS | 51 | 30.0 | 0.1 | 300 | 95 |
| 34 | 34 | 1 | 0.50 | 1 | 5.63 | 33.9 | 2.00 | SDBS | 49 | 30.0 | 0.1 | 300 | 95 |
| Comparative | 35 | 1 | 0.50 | — | — | 33.9 | 2.00 | SDBS | — | 30.0 | 0.1 | 300 | 95 |
| Example 1 | | | | | | | | | | | | | |
| Comparative | 36 | 10 | 0.50 | 1 | 18.75 | 33.9 | 2.00 | SDBS | 80 | — | 0.1 | — | — |
| Example 2 | | | | | | | | | | | | | |
| Comparative | 37 | — | — | 1 | 18.75 | 33.9 | 2.00 | SDBS | 80 | — | 0.1 | — | — |
| Example 3 | | | | | | | | | | | | | |

In the tables, the TiSr fine particle A indicates “strontium titanate fine particle A”. The APES dispersion indicates the amorphous polyester resin particle dispersion. The CPES dispersion indicates the crystalline polyester resin particle dispersion.

The SDBS indicates sodium dodecylbenzenesulfonate. The BuNSS indicates sodium butylnaphthalenesulfonate.

The adhesion rate indicates the adhesion rate of the strontium titanate fine particle having a Si-containing protrusion portion at the surface in the toner.

TABLE 4

| | | | Image density of | | | | | |
|---|---|---|---|---|---|---|---|---|
| | | Durability | portion that was | | | | Low-temperature | |
| | | evaluation | non-image portion | | | | and low-humidity | |
| | | Development | in first round of | Image density | | G* | charging leakage | |
| | | streak | sleeve | difference | | (50° C.) | (%) | |
| Example 1 | Toner 1 | A | 1.42 | 0.02 | A | 6.0 × 10⁹ | 45 | A |
| Example 2 | Toner 2 | A | 1.40 | 0.04 | A | 5.0 × 10⁹ | 48 | A |
| Example 3 | Toner 3 | A | 1.39 | 0.06 | A | 4.0 × 10⁹ | 50 | A |
| Example 4 | Toner 4 | A | 1.40 | 0.04 | A | 7.0 × 10⁹ | 48 | A |
| Example 5 | Toner 5 | A | 1.39 | 0.06 | A | 8.0 × 10⁹ | 50 | A |
| Example 6 | Toner 6 | A | 1.46 | 0.14 | B | 6.0 × 10⁹ | 52 | B |
| Example 7 | Toner 7 | A | 1.43 | 0.05 | A | 6.0 × 10⁹ | 48 | A |
| Example 8 | Toner 8 | A | 1.46 | 0.13 | B | 6.0 × 10⁹ | 52 | B |
| Example 9 | Toner 9 | A | 1.43 | 0.08 | A | 6.0 × 10⁹ | 49 | A |
| Example 10 | Toner 10 | B | 1.46 | 0.12 | B | 2.7 × 10⁹ | 52 | B |
| Example 11 | Toner 11 | B | 1.46 | 0.13 | B | 1.5 × 10⁹ | 52 | B |
| Example 12 | Toner 12 | C | 1.51 | 0.17 | C | 8.1 × 10⁸ | 63 | C |
| Example 13 | Toner 13 | A | 1.42 | 0.07 | A | 6.0 × 10⁹ | 48 | A |
| Example 14 | Toner 14 | A | 1.42 | 0.06 | A | 6.0 × 10⁹ | 48 | A |
| Example 15 | Toner 15 | A | 1.42 | 0.13 | B | 6.0 × 10⁹ | 52 | B |
| Example 16 | Toner 16 | A | 1.42 | 0.14 | B | 6.0 × 10⁹ | 52 | B |
| Example 17 | Toner 17 | A | 1.38 | 0.07 | A | 6.0 × 10⁹ | 48 | A |
| Example 18 | Toner 18 | A | 1.47 | 0.07 | A | 6.0 × 10⁹ | 48 | A |
| Example 19 | Toner 19 | A | 1.35 | 0.12 | B | 6.0 × 10⁹ | 52 | B |
| Example 20 | Toner 20 | A | 1.48 | 0.13 | B | 6.0 × 10⁹ | 52 | B |
| Example 21 | Toner 21 | A | 1.40 | 0.07 | A | 6.0 × 10⁹ | 48 | A |
| Example 22 | Toner 22 | A | 1.44 | 0.07 | A | 6.0 × 10⁹ | 48 | A |
| Example 23 | Toner 23 | A | 1.38 | 0.12 | B | 6.0 × 10⁹ | 52 | B |
| Example 24 | Toner 24 | A | 1.45 | 0.12 | B | 6.0 × 10⁹ | 52 | B |
| Example 25 | Toner 25 | A | 1.44 | 0.07 | A | 6.0 × 10⁹ | 48 | A |
| Example 26 | Toner 26 | A | 1.40 | 0.07 | A | 6.0 × 10⁹ | 48 | A |
| Example 27 | Toner 27 | A | 1.46 | 0.12 | B | 6.0 × 10⁹ | 52 | B |
| Example 28 | Toner 28 | A | 1.39 | 0.12 | B | 6.0 × 10⁹ | 52 | B |
| Example 29 | Toner 29 | A | 1.44 | 0.07 | A | 6.0 × 10⁹ | 48 | A |
| Example 30 | Toner 30 | A | 1.40 | 0.07 | A | 6.0 × 10⁹ | 48 | A |
| Example 31 | Toner 31 | B | 1.46 | 0.12 | B | 1.7 × 10⁹ | 52 | B |
| Example 32 | Toner 32 | A | 1.38 | 0.12 | B | 6.0 × 10⁹ | 52 | B |
| Example 33 | Toner 33 | A | 1.42 | 0.07 | A | 6.0 × 10⁹ | 48 | A |
| Example 34 | Toner 34 | B | 1.42 | 0.12 | B | 1.2 × 10⁹ | 52 | B |
| Comparative | Toner 35 | D | 1.51 | 0.22 | D | 5.9 × 10⁷ | 76 | D |
| Example 1 | | | | | | | | |
| Comparative | Toner 36 | A | 1.51 | 0.23 | D | 6.0 × 10⁹ | 77 | D |
| Example 2 | | | | | | | | |
| Comparative | Toner 37 | A | 1.53 | 0.30 | D | 6.0 × 10⁹ | 77 | D |
| Example 3 | | | | | | | | |

According to the present disclosure, it is possible to provide a toner that achieves a stable image density over a long period of time in a high-speed machine even in a low-temperature and low-humidity environment.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-123373, filed Jul. 30, 2024, and Japanese Patent Application No. 2025-111498, filed Jul. 1, 2025, which are hereby incorporated by reference herein in their entirety.

What is claimed is:

1. A toner comprising:
a toner particle; and
an inorganic fine particle,
wherein the inorganic fine particle contains a strontium titanate fine particle,
a Si-containing protrusion portion is present at a surface of the strontium titanate fine particle, and
the toner contains an amorphous polyester resin and an aluminum element at a surface of the toner particle.

2. The toner according to claim 1, wherein an abundance Sp (%) of the amorphous polyester resin at the surface of the toner particle by time-of-flight secondary ion mass spectrometry is 50% or more.

3. The toner according to claim 1, wherein a content C_{Al} (atomic %) of the aluminum element that is obtained by energy dispersive X-ray analysis at the surface of the toner particle is 1.0×10⁻³ to 2.0 atomic %.

4. The toner according to claim 1, wherein an abundance S_{ST} (area %) of the strontium titanate fine particle calculated from a SEM observation image of the surface of the toner is 3.0 to 50.0 area %.

5. The toner according to claim 1, wherein a value (S_{ST}/C_{Al}) of a ratio of an abundance S_{ST} (area %) of the strontium titanate fine particle calculated from a SEM observation image of the surface of the toner to a content CI (atomic %) of the aluminum element that is obtained by energy dispersive X-ray analysis at the surface of the toner particle is 20 to 2.5×10⁴.

6. The toner according to claim 1, wherein a powder specific resistance value of the strontium titanate fine particle is 1.0×10⁹ to 1.0×10¹¹ Ω·cm.

7. The toner according to claim 1, wherein when a Bragg angle of the strontium titanate fine particle is indicated by Θ, in a CuKα X-ray diffraction spectrum that is obtained in a 2Θ range of 10° to 90°,
(i) a diffraction peak a derived from a lattice plane of Miller index (111) is present in a range of 39.700°±0.150°,
(ii) a diffraction peak b derived from a lattice plane of Miller index (200) is present in a range of 46.200°±0.150°,
(iii) when an area of the diffraction peak a is indicated by Sa, and
an area of the diffraction peak b is indicated by Sb,
Sb/Sa is 1.80 to 2.30.

8. The toner according to claim 1, wherein a content percentage Uᵢₛₒ (mol %) of a monomer unit derived from isophthalic acid based on all monomer units derived from an acid component in the amorphous polyester resin is 60 mol % or more.

9. The toner according to claim 8, wherein the Uᵢₛₒ is 90 mol % or more.

10. The toner according to claim 1, wherein the toner particle contains a crystalline polyester resin.

11. The toner according to claim 1, wherein the toner particle contains at least one selected from the group consisting of dodecylbenzenesulfonic acid and dodecylbenzene sulfonate.

12. The toner according to claim 1, wherein the protrusion portion is formed of a silica fine particle.
